(19) United States
(12) Patent Application Publication
(10) Pub. No.: US 2026/0289477 A1
(43) Pub. Date: Sep. 24, 2026

(54) SYSTEM

(71) Applicant: SoftBank Group Corp., Tokyo (JP)

(72) Inventor: Yoshifumi KISHI, Tokyo (JP)

(73) Assignee: SoftBank Group Corp., Tokyo (JP)

(21) Appl. No.: 19/558,574

(22) Filed: Mar. 6, 2026

(30) Foreign Application Priority Data
Mar. 19, 2025 (JP) 2025-044504

(51) Int. Cl. G06Q 10/067; G06F 40/103; G06F 40/177; G06F 40/205; G06F 40/284; G06F 40/40; G06N 3/0455; G06N 3/0475; G06T 11/26; H04L 67/12

(52) U.S. Cl. CPC G06Q 10/0672; G06F 40/103; G06F 40/177; G06F 40/284; G06F 40/40; G06N 3/0455; G06N 3/0475; G06T 11/26; H04L 67/12; G06F 40/205

(57) ABSTRACT

A system includes a processor that is configured to receive a prompt input by a user for instructing acquisition of relevant information from at least one external information source, acquire the relevant information from the at least one external information source based on the prompt, automatically input the acquired information into a database, analyze information input into the database by using statistical analysis and machine learning algorithms to predict future business income and expenditure, and generate, based on a prediction result of the future business income and expenditure, a report in a visually understandable format and present the report to the user.

### CROSS-REFERENCE TO RELATED APPLICATION

This application is based on and claims priority under 35 USC 119 from Japanese Patent Application No. 2025-044504 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional business management systems generally require a user or manager to manually collect and input information from various external information sources, such as accounting systems, transaction databases, web services, or other business platforms, into an internal database. This manual collection and input process is time-consuming, error-prone, and highly dependent on the individual skills of the user. Furthermore, even when data is accumulated in a database, many existing systems provide only limited analytical capabilities, and do not sufficiently utilize statistical analysis and machine learning algorithms to perform accurate prediction of future business income and expenditure. As a result, it is difficult for a manager to obtain timely and reliable forecasts that support decision-making. In addition, conventional systems often lack an intuitive mechanism that allows a user to instruct acquisition of necessary external information by means of a natural-language prompt, and do not automatically interpret such prompts to retrieve and integrate relevant data into a database. Moreover, existing systems frequently fail to provide prediction results in a visually understandable report format that enables a user to quickly grasp the future business situation and use it effectively for management decisions. Therefore, there is a need for a system that can automatically acquire relevant information from external information sources based on a user's prompt, store the information in a database, perform advanced analysis including statistical analysis and machine learning, predict future business income and expenditure, and generate and present reports in a visually understandable format for supporting decision-making.

### SUMMARY

In order to solve the above-described problems, the present invention provides a system comprising a processor, wherein the processor is configured to receive a prompt input by a user for instructing acquisition of relevant information from at least one external information source, acquire the relevant information from the at least one external information source based on the prompt, and automatically input the acquired information into a database. The processor is further configured to analyze information input into the database by using statistical analysis and machine learning algorithms to predict future business income and expenditure, and generate, based on a prediction result of the future business income and expenditure, a report in a visually understandable format and present the report to the user. In one embodiment, the processor is configured to receive a prompt input by a manager for instructing acquisition of necessary information from the at least one external information source, analyze the prompt by using natural language processing, acquire the necessary information from the at least one external information source based on a result of the analysis, and import the acquired necessary information into the database. In another embodiment, the processor is configured to analyze the information input into the database by using time-series analysis and regression analysis, predict the future business income and expenditure based on a result of the analysis, and support decision-making based on a prediction result of the future business income and expenditure. By these means, the system reduces manual work for data acquisition and input, enhances the accuracy and usefulness of forecasts through advanced analytical techniques, and provides prediction results in a form that is easily understandable and directly usable for managerial decision-making.

The term “system” refers to a combination of hardware and software components, including at least one processor and associated memory and interfaces, that are configured to execute the functions defined in the claims as an integrated whole.

The term “processor” refers to one or more processing units, such as a central processing unit (CPU), a microprocessor, a digital signal processor (DSP), a graphics processing unit (GPU), or any other circuitry capable of executing instructions to perform the functions described in the claims.

The term “user” refers to any person or entity that operates or interacts with the system, including but not limited to a business operator, manager, administrator, or other personnel who provide prompts or receive reports.

The term “manager” refers to a particular type of user who is responsible for managing business operations or finances, and who uses the system to acquire information, obtain predictions of business income and expenditure, and support decision-making.

The term “external information source” refers to any system, service, database, device, or platform located outside the system that provides data relevant to business operations, such as accounting systems, banking systems, transaction databases, web services, enterprise resource planning (ERP) systems, or other business-related information systems.

The term “relevant information” refers to information obtained from at least one external information source that is related to business operations, finances, income, expenditure, or other data used for analysis and prediction of business income and expenditure.

The term “necessary information” refers to a subset of relevant information that is specifically required to perform a particular analysis, prediction, or reporting process requested by the user or manager, as determined based on the content of the prompt.

The term “prompt” refers to an instruction, request, query, or other input provided by the user or manager, typically expressed in natural language, that specifies acquisition of information from at least one external information source.

The term “natural language processing” refers to computational techniques and algorithms for analyzing, interpreting, and understanding human language input, such as the prompt, in order to extract intent, relevant entities, and parameters required to determine which information to acquire from external information sources.

The term “database” refers to any structured or semi-structured data storage system, including relational databases, NoSQL databases, data warehouses, or other persistent storage, in which acquired information is stored for subsequent analysis and reporting.

The term “automatically input” refers to the operation in which the processor stores acquired information into the database without requiring manual entry of the individual data items by the user or manager.

The term “statistical analysis” refers to the use of mathematical and statistical methods, such as aggregation, distribution analysis, correlation analysis, hypothesis testing, or other statistical techniques, to analyze information stored in the database.

The term “machine learning algorithms” refers to computational models and methods, such as regression models, classification models, clustering methods, neural networks, or other learning-based techniques, that are trained and used by the processor to detect patterns in the information and to generate predictions of future business income and expenditure.

The term “time-series analysis” refers to analytical techniques that process sequences of data indexed by time, such as historical income and expenditure data, including methods such as moving averages, autoregressive models, or other time-dependent models, for the purpose of analyzing trends and making forecasts.

The term “regression analysis” refers to analytical techniques that model relationships between one or more independent variables and a dependent variable, including linear regression, nonlinear regression, or other regression methods, to estimate or predict values related to business income and expenditure.

The term “predict future business income and expenditure” refers to the operation in which the processor generates estimated or forecasted values of future income, revenue, sales, costs, or other expenditure items for one or more future time periods based on analysis of the information stored in the database.

The term “prediction result” refers to the output of the analysis performed by the processor, including one or more estimated numerical values, ranges, or probability distributions representing future business income and expenditure.

The term “report” refers to a data representation generated by the processor that includes at least part of the prediction result and, optionally, associated explanatory or summary information, formatted for presentation to the user.

The term “visually understandable format” refers to a representation of information that can be intuitively understood by a user through visual perception, such as graphs, charts, tables, dashboards, or other graphical or formatted visual displays.

The term “present the report to the user” refers to the operation in which the processor causes the report in the visually understandable format to be output to a display device, terminal, or user interface that can be viewed or accessed by the user.

The term “support decision-making” refers to the provision of prediction results and reports by the system in such a manner that the user or manager can utilize the provided information to make informed decisions regarding business operations, resource allocation, financial planning, or other management actions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

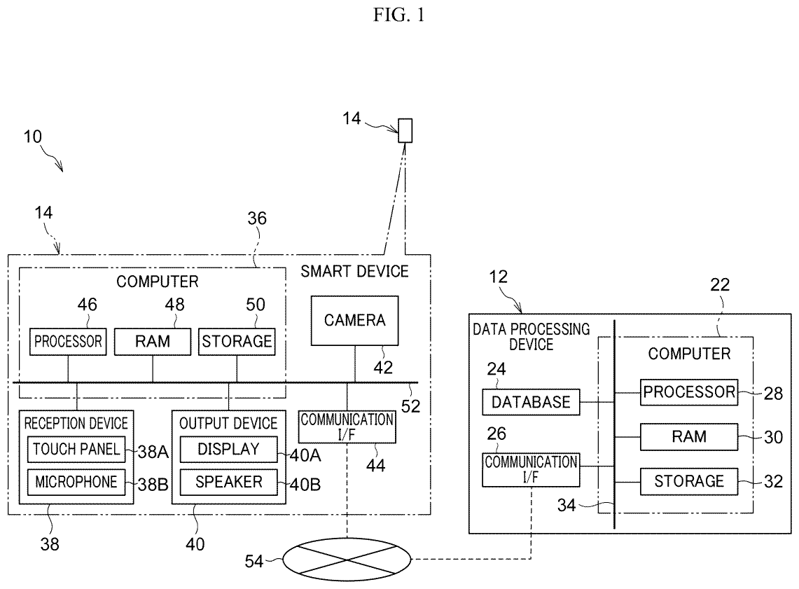

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

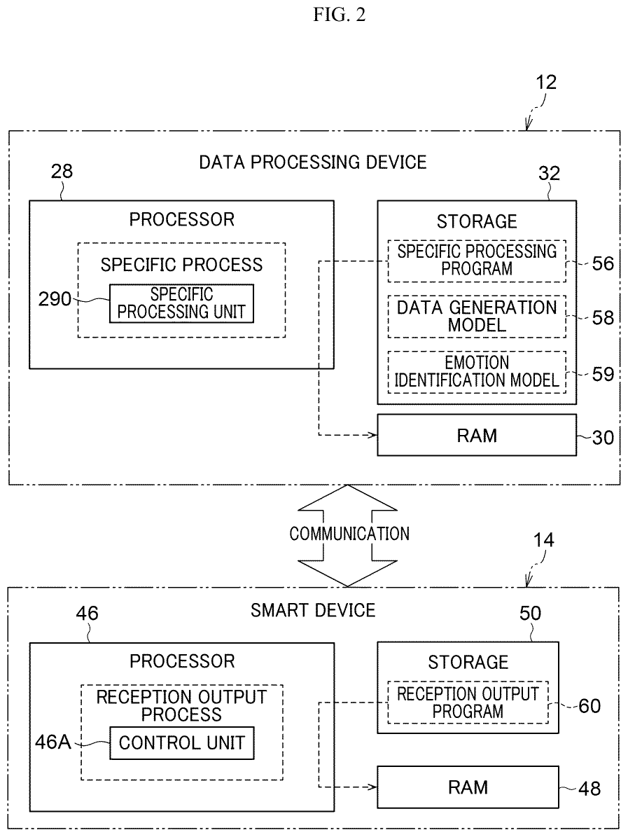

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional business information systems that acquire data from external information sources and generate management reports typically rely on rigid, pre-defined data pipelines and manually configured workflows. In such systems, technical components for data acquisition, data transformation, statistical analysis, and visualization are individually implemented and statically wired together. When a user requires a new combination of data sources, a change in analysis logic, or a different reporting format, a system administrator or developer must manually reconfigure connectors, edit scripts, or redeploy applications. This architecture causes several technical problems in the operation of computer systems.

First, the processor resources and memory resources of a server are inefficiently used because the server executes generic, one-size-fits-all data processing flows regardless of the specific user objective. Even when a user needs only a subset of data or a limited forecasting window, the server often retrieves and processes entire datasets and runs unnecessary analysis routines. This leads to increased CPU cycles, higher memory consumption, and unnecessary network traffic.

Second, conventional systems use simple keyword-based interfaces or fixed user interface forms to specify data acquisition and analysis conditions. Such input mechanisms cannot flexibly express complex multi-step workflows in a machine-interpretable manner. As a result, the server cannot autonomously generate or optimize workflows, and instead relies on static configuration files and hard-coded logic. This restriction makes it difficult for the system to adapt in real time to changing data availability, variable external information source performance, and diverse analysis requirements.

Third, existing architectures provide limited integration between natural language instructions and the internal control flow of data pipelines. Even when natural language processing is employed, it is typically used only to map user queries to pre-defined templates, and does not dynamically synthesize end-to-end workflows covering acquisition, normalization, analysis, prediction, and visualization. This results in technical overhead in orchestrating the interaction between the server, external information sources, data processing modules, and visualization components.

Fourth, monitoring and error handling are frequently implemented as afterthoughts, with separate tools or scripts that are not tightly coupled to the workflow generation and execution mechanisms. When abnormal conditions occur, such as external API timeouts, data schema changes, or processing failures, the server often cannot automatically adjust the workflow or inform the user in a timely and context-aware manner. This degrades system reliability and responsiveness.

Therefore, there is a need for an improved computer-implemented system in which a processor can (i) interpret a user's natural language prompt sentence by using a generative AI model, (ii) automatically generate machine-readable workflow information that specifies external information sources, processing steps, and output formats, (iii) orchestrate and optimize data acquisition, normalization, analysis, prediction, and visualization based on that workflow, and (iv) monitor and update the workflow execution in response to new prompts and abnormal conditions. By addressing these issues, the invention aims to improve the efficiency, flexibility, and robustness of computer-based business information processing and reporting.

The specific processing by the specific processing unit 290 of the data processing device 12 in Example 1 is realized by the following means.

The present invention provides a server comprising a processor and a memory storing instructions which, when executed by the processor, cause the processor to receive, from a terminal operated by a user, a prompt sentence expressed in natural language that specifies acquisition, processing, and presentation requirements for business-related information; to analyze the prompt sentence by using a generative AI model so as to generate workflow information in a machine-readable format, the workflow information including at least an identifier of an external information source, a target acquisition period, a type of business data to be acquired, and an output format; to control, on the basis of the workflow information, communication with a plurality of external information sources so as to automatically acquire business data via a communication network, normalize the acquired business data into a unified data schema, and store the normalized business data in a data storage device; to execute, by using a tabular data processing software library, formatting, preprocessing, and aggregation of the stored business data to generate formatted business data; to execute, by using a machine learning software framework, time-series analysis and prediction computation on the formatted business data to calculate prediction results including at least a future business balance and related indicators; to structure the formatted business data and the prediction results as report data sets and provide the report data sets to a visualization information processing device as report data sources; to cause the visualization information processing device to generate a visual report in an interactive dashboard format in which time-series graphs, aggregated tables, and indicator displays are associated with each other on the basis of layout information, and to present the visual report to the user via the terminal; to re-execute at least a part of the communication control, the formatting, the time-series analysis, the prediction computation, and the structuring of the report data sets in response to reception of a further prompt sentence from the terminal, thereby dynamically updating a content of the visual report; and to monitor execution states of the communication with the external information sources and internal data processing, detect an abnormality based on the execution states, and, upon detecting the abnormality, transmit alert information to the terminal. This enables the server to automatically synthesize and adapt data acquisition and analysis workflows from natural language prompt sentences, to reduce unnecessary processing and network load, and to improve the efficiency, flexibility, and reliability of computer-based business information processing and reporting.

The term “processor” refers to a hardware computation unit, such as a central processing unit or a computing core, that executes instructions stored in a memory to perform data acquisition, data processing, control, and communication operations of the system. The term “terminal” refers to an information processing apparatus, such as a client computer, a mobile device, or a tablet device, that is operated by a user to input a prompt sentence, to transmit the prompt sentence to the server, and to display a visual report received from the server.

The term “prompt sentence” refers to a text string expressed in natural language, input by the user via the terminal, that specifies requirements for acquisition, processing, and presentation of business-related information and serves as a basis for generation of workflow information by the server.

The term “generative AI model” refers to a software-based artificial intelligence model, such as a generative language model, that is configured to receive the prompt sentence and to output structured control information or workflow information representing data sources, processing steps, and output formats.

The term “workflow information” refers to machine-readable structured data that defines at least one external information source, a target data acquisition period, a type of business data, and an output format, and that is used by the processor to control sequences of external communication processing and internal data processing.

The term “external information source” refers to an information system, such as a database system, an application program interface endpoint, or an enterprise resource planning system, that is located outside the server and provides business data via a communication network in response to a request.

The term “business data” refers to data items related to an operation of an organization, including but not limited to sales records, expense records, inventory records, and financial transaction records, which are acquired from external information sources and processed by the server.

The term “communication network” refers to a wired or wireless data transmission infrastructure, such as a local area network or a wide area network, that enables the server to exchange data with the terminal and with external information sources.

The term “data storage device” refers to a storage apparatus or storage area, such as a magnetic disk device, a solid-state storage device, or a database system, that stores normalized business data, formatted business data, prediction results, and report data sets. The term “normalized business data” refers to business data that has been converted from heterogeneous source formats into a unified data schema with standardized field definitions, data types, and relationships, so that it can be consistently processed by subsequent data processing components.

The term “data processing program” refers to a software program executed by the processor or by a computation device, configured to perform operations including loading, transforming, aggregating, and outputting business data according to predefined or dynamically generated processing steps.

The term “tabular data processing software library” refers to a software component or library that provides operations on table-like data structures, including loading, filtering, joining, grouping, aggregating, and cleaning data arranged in rows and columns.

The term “formatted business data” refers to business data that has been subjected to formatting, preprocessing, and aggregation by the tabular data processing software library so as to be suitable as input for analysis, prediction, and reporting.

The term “machine learning software framework” refers to a software platform that provides functions for defining, training, and executing machine learning models, and that performs time-series analysis and prediction computations on formatted business data.

The term “time-series analysis” refers to processing of sequential data indexed by time, including operations such as trend extraction, seasonal decomposition, and sequence modeling, for the purpose of understanding temporal patterns in business data.

The term “prediction computation” refers to a numerical calculation executed by the machine learning software framework, based on learned parameters of a model and input business data, to estimate future values of business-related indicators, such as future business balance. The term “prediction results” refers to numerical or categorical values output by the prediction computation, including at least estimated future business balance and related performance indicators, which are used as part of report data sets.

The term “report data set” refers to a structured collection of data, including formatted business data and prediction results, that is organized as one or more data tables or data structures for use by a visualization information processing device or visualization software. The term “report generation data” refers to report data sets and associated metadata supplied from the processor to a visualization information processing device or visualization software for generating a visual report.

The term “visualization information processing device” refers to a computing apparatus or software system that receives report data sets and generates a visual report including graphical and tabular representations of the data.

The term “visual report” refers to an output representation that visually expresses report data sets by using graphical elements, such as graphs, charts, and indicators, and that is presented to the user via the terminal.

The term “graph” refers to a two-dimensional or multi-dimensional graphical representation of numerical values, such as a line chart, bar chart, or pie chart, included in the visual report.

The term “table” refers to a structured arrangement of data in rows and columns, displaying detailed or aggregated business data and prediction results in the visual report.

The term “indicator display” refers to a visual element, such as a numeric label or gauge, that displays a key performance indicator derived from formatted business data or prediction results.

The term “dashboard format” refers to a layout in which multiple graphs, tables, and indicator displays are arranged on a single screen and are configured to allow interactive operations such as filtering, drilling down, or changing views.

The term “layout information” refers to data defining positions, sizes, relationships, and interaction rules of visual elements, including graphs, tables, and indicator displays, in a dashboard-type screen.

The term “workflow execution” refers to the process in which the processor performs a series of operations, including external communication, data normalization, data formatting, time-series analysis, prediction computation, and report data structuring, according to workflow information.

The term “monitoring” refers to continuous or periodic acquisition and evaluation of execution states, including performance metrics and error states, of communication with external information sources and internal data processing components.

The term “abnormality” refers to a condition in which execution states deviate from predefined normal operation criteria, such as communication failures, processing errors, excessive delays, or inconsistent data schemas.

The term “alert information” refers to notification data generated when an abnormality is detected, the notification data including at least an identifier of the abnormality and descriptive information, and transmitted from the server to the terminal.

In one embodiment, a server cooperates with at least one terminal operated by a user to implement a system that receives a natural language prompt sentence, generates workflow information by using a generative AI model, and executes data acquisition, data processing, prediction, and visualization based on the workflow information.

The server includes a processor, a main memory, a non-volatile storage device, and one or more network interface controllers connected via a system bus. The server runs an operating system such as a general-purpose server operating system. The terminal includes a display, an input device, and a communication interface, and runs a web browser or native application that communicates with the server over a communication network such as the Internet. The server stores, in the non-volatile storage device, a set of software modules including: a prompt reception module, a generative AI model inference module, a workflow construction module, a data acquisition module, a data normalization module, a data processing module, a machine learning prediction module, a report structuring module, a visualization interface module, and a monitoring and alerting module. The server further stores trained parameters of a neural network model used as the generative AI model and a separate neural network model used for time-series forecasting.

The server receives, from the terminal, a prompt sentence expressed in natural language. The user inputs the prompt sentence using a text entry field on the terminal. For example, the user can input:
“Automatically input this month's sales data, predict next month's cash flow, and visualize the results as a report.”
or
“Fetch the last 12 months of sales, expense, and inventory data, forecast the next quarter's profit, and generate an interactive dashboard showing historical and forecasted values.”

The terminal transmits the prompt sentence and context information such as user identifier, organization identifier, and time zone to the server via a secure network protocol.

The server uses the generative AI model inference module to process the prompt sentence. In one embodiment, the generative AI model is implemented as a transformer-based neural network language model having multiple self-attention layers, feed-forward layers, and layer normalization. The server stores token embeddings, positional embeddings, and layer parameters such as attention weights and feed-forward weights in the memory. The server converts the prompt sentence into a sequence of tokens, maps the tokens to embeddings, and performs forward propagation through the transformer layers using matrix multiplication, attention score computation, and non-linear activation functions. The generative AI model outputs a sequence of tokens representing a structured description of a workflow.

The server decodes the output tokens to generate workflow information in a machine-readable format. The workflow information includes, for example, identifiers of external information sources, target data acquisition periods, categories of business data (such as sales, expenses, inventory), required preprocessing operations, model types for prediction, and desired output formats (such as dashboard or static report). The server represents the workflow information as an internal data structure, for example as nested records or a tree structure in memory, which describes a set of tasks, dependencies, and parameters.

The server uses the workflow construction module to map the workflow information to concrete processing steps and configuration. The server associates each external information source identifier with a connector configuration that specifies network endpoints, authentication methods, and data schemas. For example, the server can associate a sales database with a relational database connector using a standardized query interface, and can associate a financial service endpoint with a web-based application programming interface connector. The server creates an execution graph in memory, where nodes correspond to acquisition, normalization, processing, prediction, and visualization tasks, and edges represent data-flow dependencies.

The server controls the data acquisition module to communicate with external information sources according to the execution graph. The server establishes network connections through the network interface controllers, transmits authentication credentials, and issues queries or requests that specify the required time range and data fields. The server receives responses such as tabular query results, structured messages, or file-based exports. The server buffers the acquired data in the main memory and writes the raw records to the non-volatile storage device in a staging area.

The server uses the data normalization module to transform heterogeneous raw records into normalized business data. The server applies schema-mapping rules that convert source-specific field names and types into a unified schema. For example, the server converts different date formats into a common timestamp format, converts currency values into a standardized currency using stored exchange rates, and maps source-specific product codes into canonical identifiers. The server stores the normalized business data as relational tables or columnar data structures in a database management system running on the server.

The server uses the data processing module to perform formatting, preprocessing, and aggregation of the normalized business data. In one embodiment, the server executes a program that uses a tabular data processing software library to perform operations such as filtering records by time range, joining sales and expense tables, grouping records by time unit and category, computing aggregate measures such as sums and averages, and detecting and handling missing or anomalous values. The server stores formatted business data as intermediate tables or in-memory data structures optimized for numerical computation.

The server uses the machine learning prediction module to perform time-series analysis and prediction computation on the formatted business data. In one embodiment, the server loads a pre-trained time-series forecasting model implemented as a recurrent neural network, such as a long short-term memory network, or a transformer-based time-series model. The server constructs feature vectors from the formatted business data. For example, the server generates sequences of historical values for sales and expenses, encodes calendar features such as month-of-year and day-of-week, and optionally encodes categorical attributes such as region or product category using embedding vectors.

The server performs prediction computation by feeding the feature sequences into the time-series model. The server computes forward passes through the network layers, including matrix multiplications, gating operations, and non-linear activations. The server obtains predicted future values for one or more time horizons, such as next month or next quarter. The server optionally computes confidence intervals or uncertainty measures based on model outputs or ensemble results. The server stores the prediction results as data structures aligned with corresponding time indices and categories.

The server structures the formatted business data and the prediction results as report data sets using the report structuring module. The server generates relational tables or multidimensional data structures that combine historical and forecast values, compute derived measures such as forecast-versus-actual differences, growth rates, and ratios, and associate metadata such as units and aggregation levels. The server prepares report generation data that references these report data sets and includes layout information, for example specifying which measures and dimensions correspond to which graph or table.

The server uses the visualization interface module to provide the report data sets to a visualization information processing device or to visualization software. The server transmits data via a network interface or accesses a local visualization engine. The server instructs the visualization software to generate a visual report, such as an interactive dashboard in which time-series graphs, aggregated tables, and indicator displays are arranged according to the layout information. The server ensures that interactions on the dashboard, such as filtering by time range or category, are bound to corresponding query parameters that operate on the report data sets.

The terminal receives the visual report from the server in the form of a rendered page or an interactive view. The terminal displays the visual report on the display and allows the user to perform operations such as selecting different periods, drilling down into subcategories, or switching between different panels. The user can observe not only raw numerical values but also predicted trends and derived indicators.

The user can refine the analysis by inputting additional prompt sentences. For example, after viewing an initial dashboard, the user can input:
“Break down next month's forecasted sales by region and product category, and highlight segments with more than 20% expected growth.”

The terminal sends this further prompt sentence to the server. The server processes the new prompt sentence with the generative AI model, updates the workflow information to include more detailed segmentation and filtering, and partially re-executes only the necessary parts of the execution graph, such as additional aggregations and modified visualization layouts. The server thereby updates the report data sets and the visual report. Because the server reuses normalized business data and formatted business data when appropriate, the server avoids redundant data acquisition and reduces processing load and latency.

The server uses the monitoring and alerting module to track execution states of communication with external information sources and of internal data processing. The server collects metrics such as response times of external endpoints, error codes, throughput of data processing operations, and memory usage. The server compares the metrics against predefined thresholds or statistical baselines. When the server detects an abnormality, such as repeated timeouts, schema mismatches, or excessive delay, the server generates alert information that describes the abnormality and its context. The server transmits the alert information to the terminal, enabling the user or an administrator to take appropriate action. In some embodiments, the server modifies the workflow information in response to certain abnormalities, for example by switching to alternative data sources or by adjusting prediction horizons, thereby maintaining service continuity.

The server achieves technical improvements over conventional systems in several ways. Because the server uses the generative AI model to generate workflow information that directly configures data acquisition, normalization, and processing modules, the server can tailor execution paths to the specific content of each prompt sentence. This reduces the volume of unnecessary data retrieval and processing, thereby reducing communication load and computation time. For example, when the prompt sentence specifies only “this month's sales data,” the server limits queries to a narrow time range instead of retrieving multi-year histories.

The server improves computing efficiency by representing the workflow information as a structured execution graph rather than as a rigid, pre-scripted pipeline. The generative AI model generates, in one inference pass, a specification that defines which external connectors, which normalization rules, which aggregation operations, and which prediction models are needed for a particular request. The server then compiles this specification into an execution graph and caches certain graph components. For repeated or related prompt sentences, the server can reuse portions of the execution graph and intermediate results, thereby reducing redundant processing and improving throughput.

The server uses specific neural network architectures and training procedures in a way that is tuned to this workflow-generation problem. For the generative AI model, the server can use a transformer model trained with a vocabulary that includes tokens corresponding to domain-specific concepts such as “sales_data,” “forecast_horizon,” and “dashboard_layout.” The server trains this model using supervised learning on pairs of prompt sentences and corresponding workflow specifications. During training, the server applies an objective function such as cross-entropy over the sequence of workflow tokens and updates model weights using gradient descent with a variant of stochastic optimization. The server optionally uses data augmentation techniques such as paraphrasing prompt sentences and sampling alternative workflow structures to increase model robustness.

For the time-series prediction model, the server can use an architecture designed to capture seasonal and trend patterns in business data. The server trains the model on historical time-series stored in the data storage device, using a loss function such as mean squared error or mean absolute percentage error, and applies techniques such as regularization and early stopping to improve generalization. The server stores the trained model parameters in non-volatile storage and loads them into memory for fast inference. Because the forecasting model is integrated with the workflow information, the server can dynamically adjust input sequences and prediction horizons according to the prompt sentence.

The server performs data management improvements by maintaining a unified normalized schema and by automatically generating aggregation and indexing strategies based on recurrent access patterns inferred from prompt sentences. For example, when the server observes that many prompt sentences request monthly aggregates by region, the server can create or adjust indexes and materialized views optimized for that access pattern. This reduces query times and lowers CPU and I/O load in subsequent executions.

The server also employs non-conventional rule sets and procedures that differ from manual human workflows. A human operator might manually select data sources and construct queries or reports for each request, typically redoing similar steps. In contrast, the server uses the generative AI model to encode rules and patterns that map language expressions to structured workflows, including selection of appropriate predictors, transformations, and visualization combinations. The server applies these rules consistently and at scale, and optimizes them based on performance metrics, which a human operator would not typically do across many executions.

In another embodiment, the server can host the generative AI model and the time-series model on a separate accelerator device such as a graphics processing unit or a specialized neural network accelerator. The server transfers tokenized prompt sentences and feature representations over a high-speed internal bus to the accelerator. The accelerator performs matrix multiplications and activation computations in parallel, and returns logits or predicted values to the server. By offloading these computations, the server reduces latency and allows the processor to focus on orchestrating data flows and network communications.

In a further embodiment, the server can maintain multiple alternative prediction models or normalization strategies and use the workflow information to select among them. For example, when the prompt sentence indicates a short-term forecast, the server can select a model that emphasizes recent data with a shorter input window, while for long-term forecasts the server can select a model that incorporates more historical context. The server can record prediction errors over time and adjust model selection rules and hyperparameters, thereby improving accuracy and computational efficiency.

The server is not limited to a specific business domain. The server can be configured with different sets of external information sources, schemas, and models for domains such as manufacturing, logistics, or energy consumption. In each case, the same basic mechanism applies: the server uses the generative AI model to translate prompt sentences into workflow information that configures domain-specific connectors, transforms, models, and visualizations. This modular design allows the server to reuse core technical components while adapting to different types of data and analysis.

The described embodiments focus on the internal technical processing performed by the server and the cooperation between the server and the terminal. The server implements a concrete data flow and computational architecture, including specific data structures, neural network models, and monitoring mechanisms, that improve processing speed, prediction accuracy, data management, and communication efficiency. By generating and adapting workflows in response to natural language prompt sentences in a machine-optimized manner, the server provides improvements to computer technology that go beyond mere automation of human tasks.

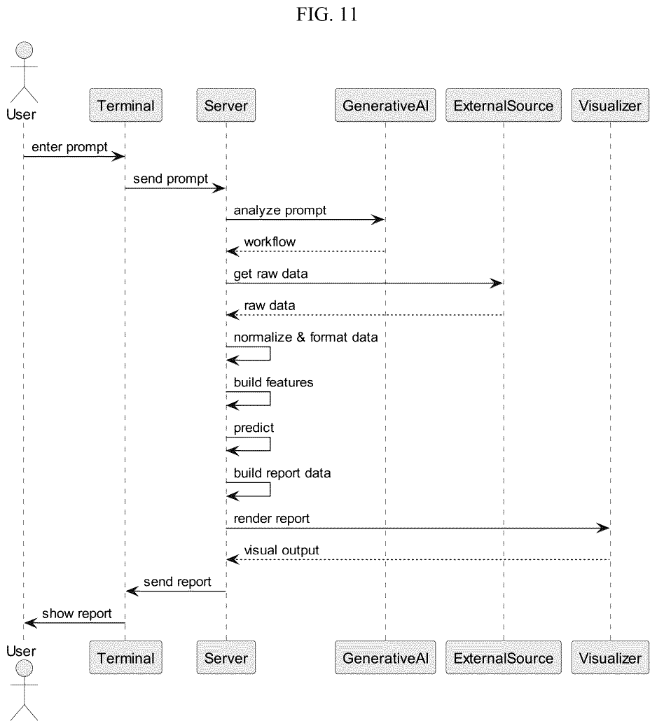

The following describes the processing flow using FIG. 11.

### Step 1:

The user inputs a prompt sentence on the terminal.

The user enters a natural language instruction into a text field, such as “Automatically input this month's sales data, predict next month's cash flow, and visualize the results as a report.” The terminal receives the prompt sentence as input together with context data such as user ID, organization ID, and time zone.

The terminal packages the prompt sentence and the context data into a request message and transmits the request to the server over a secure communication protocol.

The output of Step 1 is a network request containing the prompt sentence and context data delivered to the server.

### Step 2:

The server receives the network request from the terminal.

The server parses the request to extract the prompt sentence and the context data, and stores them in a request buffer in memory.

The server performs basic validation, such as checking character encoding and maximum length, and logs the reception event.

The input of Step 2 is the network request produced by Step 1, and the output is a validated prompt sentence and associated context stored in the server's memory.

### Step 3:

The server tokenizes the prompt sentence for input to the generative AI model.

The server converts the prompt sentence into a sequence of tokens using a predetermined tokenizer, assigns each token an integer ID, and constructs an input tensor representing the token IDs and positions.

The server uses the context data (for example, time zone or organization type) to append special tokens or tags indicating domain and user conditions.

The input of Step 3 is the validated prompt sentence and context, and the output is an encoded token sequence and positional information ready for generative AI model inference.

### Step 4:

The server executes the generative AI model to interpret the prompt sentence.

The server loads model parameters of a transformer-based language model from storage into memory if they are not already loaded, and performs forward propagation on the input tensor. The server computes attention scores, weighted sums of value vectors, and feed-forward layer outputs to generate a sequence of output tokens that represent a structured workflow description.

The input of Step 4 is the encoded token sequence from Step 3, and the output is a sequence of output tokens that encodes workflow information for data acquisition, processing, and reporting.

### Step 5:

The server decodes the output tokens into workflow information.

The server maps each output token to a symbolic element, such as an external source identifier, a time range, a data type, a processing operation, or an output format, and assembles these elements into a structured internal representation.

The server constructs a workflow object that includes a list of tasks (for example, “acquire_sales_data,” “normalize_currency,” “forecast_cash_flow,” “generate_dashboard”) and their parameters and dependencies.

The input of Step 5 is the output token sequence from Step 4, and the output is workflow information represented as an internal data structure stored in memory.

### Step 6:

The server constructs an execution graph from the workflow information.

The server analyzes tasks and their dependencies described in the workflow object and creates nodes for each task and directed edges for data dependencies between tasks.

The server assigns execution priorities and determines which tasks can be run in parallel, and computes an optimized ordering of tasks based on resource availability and expected data volume.

The input of Step 6 is the workflow information from Step 5, and the output is an execution graph that specifies the order and concurrency of subsequent processing.

### Step 7:

The server acquires raw business data from external information sources according to the execution graph.

The server reads connector configurations for each external source node (such as a database endpoint or web API endpoint), opens network connections, and issues queries or requests that are parameterized by the time range and data type specified in the workflow information. The server receives responses in formats such as tabular result sets, structured messages, or file payloads, checks for errors, and writes the raw data into a staging area in the server's storage.

The input of Step 7 is the execution graph specifying data acquisition tasks, and the output is raw business data records stored in the staging area.

### Step 8:

The server normalizes the raw business data into a unified schema.

The server loads schema-mapping rules that define how source-specific fields map to canonical field names, types, and units, and applies these rules to each raw record.

The server converts date and time fields to a standard timestamp format, converts currency amounts using stored exchange rates to a reference currency, and standardizes identifiers such as product codes and customer IDs.

The input of Step 8 is the raw business data from Step 7, and the output is normalized business data stored as relational tables or structured records in a data storage device.

### Step 9:

The server formats and aggregates the normalized business data using a tabular data processing library.

The server loads normalized tables into in-memory tabular structures and applies filters based on the workflow information, such as limiting records to the specified time range.

The server performs joins between tables (for example, joining sales and expense tables by time), groups records by dimensions such as month, region, or product category, and computes aggregated measures such as totals, averages, and variances.

The server detects missing values and outliers and applies predefined handling rules, such as imputing missing values based on historical averages or removing extreme outliers.

The input of Step 9 is the normalized business data from Step 8, and the output is formatted business data in tabular structures suitable for model input.

### Step 10:

The server constructs feature vectors and sequences for time-series prediction.

The server selects relevant columns from the formatted business data, such as revenue, expenses, and inventory levels, and organizes them into chronological sequences according to time indices.

The server adds auxiliary features, such as numerical encodings of calendar information (for example, month number, day-of-week, holiday flags) and categorical embeddings for dimensions like region or product category.

The server scales numerical features using predetermined normalization parameters (such as mean and standard deviation) to improve numerical stability in the prediction model.

The input of Step 10 is the formatted business data from Step 9, and the output is a set of feature tensors representing historical sequences and auxiliary features.

### Step 11:

The server executes a time-series prediction model on the feature tensors.

The server loads parameters of a pre-trained forecasting model, such as a recurrent neural network or transformer-based time-series model, and performs forward passes on the feature tensors.

The server computes layer outputs through matrix multiplications, non-linear activations, and sequence operations (such as recurrent updates or attention weighting), and produces predicted future values for each target variable and time horizon defined in the workflow information.

The input of Step 11 is the feature tensors from Step 10, and the output is prediction results represented as arrays or tables with predicted values and corresponding future time indices.

### Step 12:

The server post-processes the prediction results.

The server converts normalized prediction outputs back into original units by applying inverse scaling or de-normalization operations, and optionally computes confidence intervals or error bounds using stored model statistics or ensembles.

The server aligns prediction results with business dimensions (such as region or product category) and merges them with historical values to form continuous time series covering both past and future periods.

The input of Step 12 is the raw prediction output from Step 11, and the output is a set of prediction tables ready to be combined with formatted business data for reporting.

### Step 13:

The server constructs report data sets from formatted business data and prediction results. The server joins historical tables and prediction tables along common keys such as time, region, or category, and computes derived measures like differences between forecast and historical averages, growth rates, and ratios such as profit margin.

The server adds metadata describing units, aggregation levels, and display preferences, and organizes the combined data into one or more report tables or multidimensional structures. The input of Step 13 is the formatted business data from Step 9 and the prediction tables from Step 12, and the output is report data sets suitable for visualization.

### Step 14:

The server generates layout and binding information for a visual report.

The server reads layout templates specified or implied in the workflow information and determines which measures and dimensions are mapped to which visual components, such as line graphs, bar charts, or summary indicators.

The server constructs binding rules that associate filters (such as time range sliders or category selectors) with corresponding query parameters on the report data sets.

The input of Step 14 is the report data sets from Step 13 and the layout part of the workflow information, and the output is a set of visualization configuration objects defining a dashboard structure.

### Step 15:

The server transmits report data sets and visualization configuration to a visualization engine. The server packages the report data sets and layout information into a request suitable for a visualization information processing device or built-in visualization software, and sends the request via a network connection or local interface.

The server receives a rendered representation, such as a dashboard description or a pre-rendered document, from the visualization engine after the engine has executed chart generation and layout rendering.

The input of Step 15 is the report data sets and visualization configuration from Step 14, and the output is a visual report representation ready to be delivered to the terminal.

### Step 16:

The server delivers the visual report to the terminal.

The server embeds the visual report representation in a response message, such as a web page or application payload, and transmits it to the terminal over the communication network. The terminal receives the response, parses the content, and displays the dashboard or report on its display, rendering graphs, tables, and indicators according to the received layout. The input of Step 16 is the visual report representation from Step 15, and the output is a visual report displayed on the terminal for the user to view and interact with.

### Step 17:

The server monitors execution metrics and detects abnormalities during or after processing. The server collects metrics such as external API response times, error codes, number of acquired records, processing duration for each task node in the execution graph, and resource usage.

The server evaluates the metrics against thresholds and rules, and when conditions indicating failure or degradation are detected, the server generates alert information describing the affected task, error type, and impact.

The input of Step 17 is runtime execution state data gathered throughout Steps 7 to 15, and the output is either a confirmation of normal operation or alert information stored and prepared for notification.

### Step 18:

The server notifies the terminal of abnormalities and optionally adjusts the workflow.

The server sends alert information to the terminal, including textual messages such as “External sales data source timed out; using cached data for the last 24 hours,” and may also include suggested corrective actions.

The server modifies the workflow information or execution graph when certain error conditions are met, such as switching to a fallback data source or reducing the requested time range, and then re-executes affected parts of the pipeline.

The input of Step 18 is the alert information and detected conditions from Step 17, and the output is an updated workflow state and an alert notification received and displayed by the terminal.

### Step 19:

The user refines the request by inputting a new prompt sentence based on the displayed report or alerts.

The user analyzes the visual report and, if additional detail or alternative views are needed, inputs another prompt sentence, such as “Show the forecasted cash flow by region and highlight any region with negative cash flow.”

The terminal sends the new prompt sentence to the server, and the server reuses existing normalized and formatted data where possible, reconstructs or updates workflow information, and repeats selected steps (for example, Steps 3 through 15) to generate an updated report. The input of Step 19 is the current visual report and any alert information, and the output is a new prompt sentence initiating a partially recalculated and optimized processing flow on the server.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented production management and business analytics systems primarily acquire data from limited internal databases and require substantial manual configuration by users. In such systems, a user must manually specify data sources, perform data cleansing, align timestamps, and design analysis workflows. As a result, the underlying computer platform executes fragmented processing steps with low automation, causing high latency between data acquisition and decision making. This increases processor load due to redundant data handling and leads to inefficient use of memory and storage resources. Furthermore, conventional systems typically separate analytical processing from optimization proposal generation. Statistical analysis modules and machine learning modules may predict future performance indices, but proposals for optimization are often created manually by human operators based on static templates. Even when a generative model is used, it is usually invoked in an ad hoc manner, with free-form prompts manually drafted by the user. Accordingly, the generative model has limited access to structured analytical context, which reduces the relevance and consistency of the generated output. This fragmentation prevents the computer from exploiting the full value of its stored time-series data and analysis results, and forces users to act as a “glue layer” between subsystems.

In addition, prior systems do not provide a unified, computer-controlled mechanism for transforming heterogeneous sensor data and external information into a form that can be automatically incorporated into a context-aware prompt for a generative model. Time-series sensor streams, anomaly detection results, and historical operational constraints are often stored in different data silos. As a consequence, the processor must execute multiple independent retrieval and transformation operations when responding to a user's request, leading to increased processing overhead, higher memory bandwidth consumption, and delays in generating insights.

There is also a technical problem in how alerts and optimization decisions are managed. In many existing implementations, anomaly detection and alerting occur in one subsystem, while optimization advice and user decisions are recorded in another. The processor cannot efficiently correlate real-time events with past proposals and user feedback, limiting the system's ability to refine future prompts or model usage. From the perspective of computer technology, these disjointed operations waste computation cycles, complicate data structures, and make it difficult to implement efficient caching, indexing, and reuse of analytical context. Accordingly, there is a need for a computer-implemented technique that improves operation of the processor, memory, and storage by (i) automatically converting raw internal and external data into analysis-ready representations, (ii) tightly integrating statistical and machine-learning analysis with generative model prompt generation, and (iii) structuring proposal generation and user interaction in a manner that is natively supported by the server architecture. By reorganizing the data flow and processing steps within the server, the system can reduce redundant computations, standardize the representation of analysis context, and more efficiently drive a generative AI model to produce relevant optimization proposals, thereby improving the functionality and performance of the underlying computer system itself.

The specific processing by the specific processing unit 290 of the data processing device 12 in Application Example 1 is realized by the following means.

The present invention provides a server comprising a processor configured to acquire time-series data from sensing devices and information from external sources, normalize and aggregate such data into analysis data stored in a storage device, execute statistical analysis and machine learning analysis on the analysis data to generate prediction results and anomaly-detection results, automatically construct a structured prompt sentence including summary information of the prediction results, anomaly-detection results, performance indices, operating conditions, and constraint conditions, input the structured prompt sentence into a generative AI model to obtain proposal information in natural language, and store and present the proposal information in association with corresponding analysis results and event records while recording user acceptance or rejection of individual proposals. This enables the server to internally orchestrate data acquisition, preprocessing, analytical computation, prompt construction, and generative inference as a unified pipeline, thereby reducing redundant processing, improving utilization of processor and memory resources, and enhancing the relevance and timeliness of optimization proposals generated by the computer system.

The term “time-series data” refers to data items each associated with a time stamp and representing values of one or more variables observed or measured at successive points in time.

The term “sensing device” refers to a hardware device configured to measure a physical or operational quantity in an environment, such as temperature, pressure, vibration, throughput, or status of equipment, and to output corresponding digital data.

The term “communication network” refers to a wired or wireless data transmission infrastructure that enables exchange of digital information between the server and other devices, including local area networks, wide area networks, and public or private packet-switched networks.

The term “storage device” refers to a hardware and software combination for storing digital data, including non-volatile storage such as magnetic disks, solid-state drives, or network-attached storage, and logical structures such as databases or file systems.

The term “raw data” refers to data acquired directly from a sensing device or external information source before being subjected to cleansing, transformation, normalization, or aggregation processing.

The term “analysis data” refers to data that has been derived from raw data by applying operations such as format conversion, normalization, attribute assignment, and aggregation, and that is structured so as to be suitable for statistical analysis and machine learning.

The term “external information source” refers to a data provider located outside the server, including remote databases, web services, application programming interfaces, or other computer systems that supply information relevant to analysis and prediction.

The term “format conversion” refers to processing that changes the representation of data, including converting data encodings, file formats, or data types, so that heterogeneous input data can be treated in a unified schema.

The term “time normalization” refers to processing that converts time-related information into a consistent time base or standard, including adjusting time zones, aligning sampling intervals, and resolving inconsistent or missing timestamps.

The term “attribute assignment” refers to processing that links data items with contextual information such as identifiers of equipment, production lines, products, shifts, or operational states.

The term “aggregation processing” refers to processing that groups multiple data items into larger units based on criteria such as time intervals, equipment identifiers, or categories, and calculates summary values such as sums, averages, counts, or rates.

The term “statistical analysis function” refers to a software-implemented capability that performs operations based on statistical methods, including calculation of distributions, variances, correlations, and time-series statistics.

The term “machine learning function” refers to a software-implemented capability that applies a trained model or learning algorithm to input data in order to perform tasks such as prediction, classification, or anomaly detection.

The term “performance index” refers to a quantitative metric used to evaluate an aspect of operational activity, including but not limited to throughput, defect rate, utilization, response time, or efficiency.

The term “anomaly-occurrence interval” refers to a time period during which the behavior of a performance index deviates from an expected pattern beyond a predetermined threshold, as determined by statistical or machine learning analysis.

The term “efficiency-degradation interval” refers to a time period identified by analysis in which a performance index indicating efficiency is lower than a reference level or expected trend.

The term “prediction result” refers to an output value or set of values computed by applying statistical analysis or a machine learning model to analysis data, representing estimated future values of performance indices or other variables.

The term “detection result” refers to an output value or set of values indicating whether an anomaly, bottleneck, or other event has been identified in the data by analysis processing. The term “evaluation index” refers to a calculated metric derived from prediction results or detection results and used to assess severity, risk level, or significance of a condition in the system.

The term “event record” refers to a data structure stored in the storage device that represents the occurrence of an event, including at least an identifier, a timestamp, a type of event, and information related to a determination result.

The term “visualization program” refers to software that transforms numerical or categorical data into graphical or tabular representations, such as charts, graphs, or lists, suitable for presentation on a display device.

The term “report data” refers to data structures generated for presentation purposes that include at least one of time-series graphs, bar graphs, and lists of indices, and that summarize analysis results and event records.

The term “visualization information” refers to information formatted so as to be rendered on a display device, including layout definitions, graphical elements, and associated data values. The term “user terminal” refers to an electronic device operated by a user, such as a workstation, portable computer, or handheld device, configured to communicate with the server and to present a user interface.

The term “user interface” refers to a software-controlled interaction layer that enables a user to view information from the server and to input commands, selections, or text through visual, auditory, or tactile components.

The term “prompt sentence” refers to a sequence of natural-language characters or tokens provided to a generative AI model as input in order to specify a task, constraints, or context for generating output.

The term “generative AI model” refers to a machine learning model configured to generate natural-language text or other content in response to an input prompt sentence, based on patterns learned from training data.

The term “proposal information” refers to natural-language content generated by the generative AI model that describes suggested actions, optimization strategies, or recommendations related to operational efficiency or system behavior.

The term “summary information” refers to condensed descriptive data derived from more detailed analysis results and time-series data, capturing essential statistics, patterns, and notable events in a compact textual or structured form.

The term “operating condition” refers to a state or configuration under which a system or process is running, including parameters such as load level, shift schedule, machine settings, and resource availability.

The term “constraint condition” refers to a limitation or requirement that restricts how optimization or control actions may be chosen, including constraints on capacity, cost, time, resources, or regulatory requirements.

The term “acceptance or rejection instruction” refers to user input indicating that the user approves or disapproves of a particular proposal item and that is stored by the server as a status associated with the proposal item.

The term “comment input” refers to user-provided text associated with a proposal item, including notes, justifications, or modifications, which is stored together with the acceptance or rejection instruction.

The term “decision-support information” refers to information, including at least proposed schedule modifications, maintenance timing candidates, and personnel allocation adjustments, that assists a user in making operational decisions based on analysis and prediction results.

In one embodiment, a server executes a set of software modules stored in a non-transitory computer-readable medium to implement the claimed system. The server includes a central processing unit (CPU), a main memory, a persistent storage device such as a magnetic disk or solid-state drive, and a network interface connected to a communication network. The server cooperates with one or more sensing devices installed in a physical environment, such as a factory, and with at least one user terminal. The user terminal includes a display and an input interface and executes a web browser or dedicated client application.

The server acquires time-series data from the sensing devices. The server uses a network protocol such as HTTP, MQTT, or a fieldbus gateway and executes software libraries, for example an HTTP client library and a message queue client library, to receive measurement values including timestamps, equipment identifiers, operating states, and process variables such as throughput or temperature. The server writes each received data item as raw data into a storage device, in a database schema that includes at least a sensor identifier, a timestamp, a measured value, and a data type field. The server may employ a relational database management system or a time-series database for this purpose.

The server converts the raw data into analysis data suitable for statistical analysis and machine learning. The server executes an information processing program implemented, for example, using a high-level language runtime and a data processing library such as a tabular data manipulation library and a numerical computation library. The server parses incoming payloads, converts string values into typed numeric or categorical values, normalizes timestamps into a unified reference time, and assigns attributes indicating a production line, a physical location, or an operational mode. The server aggregates multiple raw data items into fixed-length time windows, such as one-minute or five-minute intervals, and computes summary statistics such as counts, averages, standard deviations, and minimum and maximum values. The resulting analysis data is stored in structured tables that are indexed by equipment identifier and time, enabling efficient retrieval for subsequent computation.

The server analyzes the analysis data using both statistical analysis and a machine learning model configured for time-series prediction and anomaly detection. In one embodiment, the server loads a trained neural network model from the storage device and initializes a machine learning framework runtime. The neural network may be implemented as a recurrent neural network, such as a long short-term memory (LSTM) network, or as a temporal convolutional network. The model receives, as input features, sequences of performance indices and sensor values, including throughput, defect counts, downtime flags, and environmental measurements over a sliding window. The server normalizes each feature dimension using precomputed scaling parameters stored in the storage device.

The server applies an inference algorithm in which the CPU (or optionally a graphics processing unit) performs matrix multiplications and non-linear activation operations according to the neural network architecture. The server calculates prediction results that represent future values of performance indices for one or more prediction horizons, such as 10 minutes, 30 minutes, or one hour ahead. The server also calculates anomaly scores by comparing predicted values with observed values using a residual error metric. In one example, the server computes an anomaly score as a weighted sum of squared residuals over the prediction horizon and compares the anomaly score with a learned or configured threshold to generate detection results.

The server computes evaluation indices from the prediction results and detection results. The server derives, for each equipment and each time interval, one or more indices such as a risk score representing the probability or severity of a future bottleneck, and an efficiency-degradation index representing an expected deviation below target throughput. The server records event records in the storage device when any evaluation index exceeds a threshold. Each event record includes a timestamp, an affected equipment identifier, a type of event (such as “predicted efficiency drop” or “anomaly detected”), and associated evaluation indices. By recording such event records in a compact and indexed format, the server reduces the amount of data that must be scanned for subsequent operations, improving memory usage and query performance.

The server generates report data and visualization information for presentation at the user terminal. The server executes a visualization program, implemented for example using a plotting library on the server side or a charting library via an application server framework, and converts analysis data and event records into time-series graphs, bar graphs, and index tables. The server structures the report data as a set of data series, labels, and layout specifications, and stores them temporarily or persistently in the storage device. The server then generates a view definition, such as a markup page with embedded visualization instructions, which is transmitted to the user terminal.

The terminal receives the visualization information from the server. The terminal executes a browser engine or client application that parses the received view definition, renders charts and tables on the display device, and accepts user inputs such as selection of time ranges, equipment identifiers, and analysis modes. The terminal sends these user inputs back to the server via the communication network as parameterized requests.

The user operates the terminal to review the report data and event records. The user requests additional details for a specific event, such as a repeated efficiency-degradation interval for a given production line. The user may also request that the system generate optimization proposals for a specified time range and equipment set.

The server constructs a structured prompt sentence for a generative AI model based on the analysis results and event records. The server retrieves, from the storage device, summary information for the requested context, including aggregated performance indices over a specified period, lists of anomaly-occurrence intervals, and relevant operating conditions and constraint conditions. The server generates a text representation that includes these statistics, for example mean throughput, variance, maximum anomaly score, and frequencies of specific event types. The server then composes a prompt sentence that combines a role instruction, the summary information, and an explicit request for recommendations.

In one example, the server generates a prompt sentence such as:
“You are an expert in optimizing production efficiency in automated manufacturing systems. The server has collected and preprocessed the last 1 month of production data, including throughput, defect rate, and downtime per line. For Line A, efficiency is consistently 15% lower than target between 14:00 and 16:00, and anomaly scores based on prediction residuals exceed a threshold of 2.5 during these intervals. Analyze this summarized data and generate concrete proposals to optimize efficiency, focusing on improving throughput during the 14:00-16:00 time window on Line A. Provide actionable steps, estimated impact on throughput, and any required changes to operating conditions under the constraint that total labor hours must not increase.”

In another example, the server uses a prompt sentence such as:
“Analyze the past 1 month of production data summarized as follows: average throughput 100 units/hour, standard deviation 20 units/hour, maximum anomaly score 3.0, and repeated downtime events at 10:00 and 15:00. Generate recommendations to optimize overall production efficiency, including schedule changes, maintenance timing, and staffing adjustments. Present the proposals as a prioritized list with reasons and expected improvements in performance indices.”

The server transmits the constructed prompt sentence to a generative AI model. The server uses an application programming interface exposed by a model hosting service or a local model server and sends the prompt sentence as an input sequence of tokens. The generative AI model may be implemented as a transformer-based neural network with multiple self-attention layers and feed-forward layers, trained on large text corpora and optionally fine-tuned on domain-specific operational data. The server sets inference parameters such as maximum output length and sampling temperature to ensure that the generated proposal information is concise and deterministic enough for operational use.

The server receives the output from the generative AI model as a natural-language response. The server parses the response, identifies individual proposal items, and optionally structures them into records that include categories such as schedule modification, maintenance action, and parameter adjustment. The server then stores the proposal information in the storage device in association with the corresponding analysis results and event records that were used to construct the prompt sentence. Each proposal record is linked to the particular prompt sentence and the generative AI model version to enable later auditing and re-evaluation. The terminal presents the proposal information to the user. The terminal displays each proposal item in a dedicated area linked to the corresponding visualization of performance indices and events. The user reviews each proposal, and the terminal provides interface elements for the user to indicate acceptance or rejection and to enter comments or modifications. The terminal transmits the user's acceptance or rejection instructions and comment inputs back to the server.

The server records the user feedback in the storage device. The server updates the proposal records to include status fields indicating whether each proposal has been accepted or rejected and stores any associated comments. The server may use this feedback in future operations to adjust prompt construction rules, for example, by learning which types of proposals are frequently accepted and emphasizing those in subsequent prompt sentences. By maintaining a structured history of prompts, generative outputs, and user decisions, the server improves the efficiency of future inference by reusing contextual patterns and reducing unnecessary model calls.

In one embodiment, the server implements a training and updating process for the machine learning model used for prediction and anomaly detection. The server periodically samples historical analysis data and event records from the storage device and forms training datasets consisting of input sequences and target sequences. The server defines a loss function, for example a mean squared error between predicted and actual performance indices, optionally combined with a term penalizing misclassification of anomaly events. The server executes a training algorithm such as stochastic gradient descent or an adaptive gradient method to update the weights of the neural network model. The server computes gradients of the loss function with respect to model parameters and updates the parameters by applying learning rates and regularization terms. The server may also perform data augmentation operations such as adding small noise or scaling to input sequences to improve model robustness. By incorporating updated event records and feedback from accepted proposals into training, the server refines its predictive capability and reduces prediction errors over time.

In another embodiment, the server uses a rule-based post-processing module in combination with the machine learning model. The server defines non-conventional rules that operate on model outputs and evaluation indices, such as rules that detect repeated anomaly patterns aligned with specific shifts or machine warm-up periods. These rules are not limited to simple threshold comparisons and may involve pattern matching across multiple time windows and equipment identifiers. The server applies these rules to refine the identification of efficiency-degradation intervals and to adjust the content of the prompt sentence. This hybrid configuration enables the server to apply domain-specific logic that would be difficult for a human operator to apply continuously and consistently, thereby improving detection accuracy and reducing false positives and false negatives.

From a computer-technology perspective, the server improves processing efficiency and data management by enforcing a specific data flow and data structures. The server maintains separate, indexed tables for raw data, analysis data, event records, report data, prompts, and proposals. The server organizes these tables so that most processing steps operate on compact, aggregated analysis data rather than on full raw streams, reducing memory bandwidth consumption and disk I/O operations. The server also caches frequently used summary information and reuses it when generating new prompts, avoiding full recomputation of statistics for each user request. These structural features result in faster response times for prompt generation and proposal retrieval compared to naive implementations that recompute summaries from scratch or rely on ad hoc query logic.

The described system is not limited to production environments. In a variant embodiment, the sensing devices provide time-series data from an information technology infrastructure, such as server load, network latency, or error counts, and the performance indices represent availability, latency, or resource utilization. The server performs the same analysis and generative proposal generation to recommend configuration changes, maintenance windows, or resource allocation adjustments to improve computing infrastructure efficiency. In another variant, the sensing devices monitor environmental parameters in a building, and the proposals concern optimization of heating, ventilation, and air conditioning control. In each case, the server uses specific technical processing steps and data structures to reduce computation overhead and improve accuracy of predictions and anomaly detection, and then generates context-aware prompt sentences to drive the generative AI model.

The terminal and the user cooperate with the server to close the loop between analysis and action. The terminal presents unified visualizations and proposal information, and the user applies domain knowledge selectively by accepting, rejecting, or modifying proposals. The server uses this feedback to refine both its analytical models and prompt construction rules. As a result, the system as a whole achieves improved computational efficiency, higher prediction accuracy, and reduced communication and storage load, while providing a concrete technical improvement over systems that rely solely on manual prompt design, ad hoc analysis routines, or fragmented data handling.

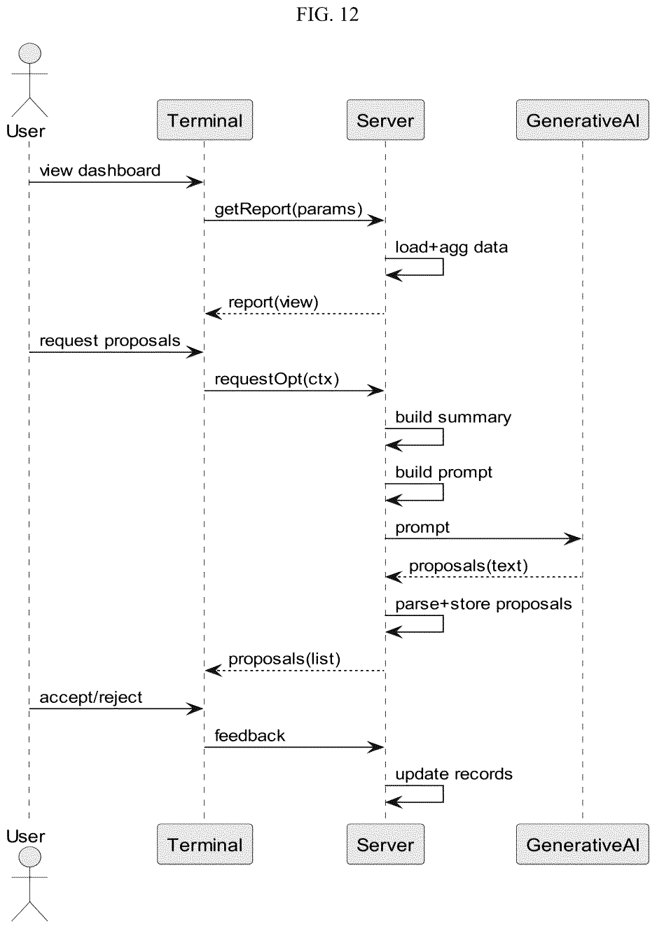

The following describes the processing flow using FIG. 12.

### Step 1:

The server acquires raw time-series data from sensing devices. The server receives, as input, measurement packets that include at least a sensor identifier, a timestamp, and one or more measured values such as throughput, temperature, or vibration. The server uses a communication library to decode the packets, verifies checksums, and discards corrupted frames. The server writes each valid measurement as a raw data record into a storage device, assigning a unique record identifier. The output of this step is a set of raw data records persisted in a raw-data table indexed by sensor identifier and timestamp.

### Step 2:

The server converts the raw data into a normalized internal format. The server reads, as input, raw data records from the raw-data table for a specified time range. The server performs format conversion by parsing string representations into numeric types, mapping categorical codes to internal category identifiers, and converting all timestamps to a unified reference time zone. The server also performs basic validation by clamping values outside of physically possible ranges and marking them as invalid. The output of this step is a stream of cleaned records with consistent data types and normalized timestamps.

### Step 3:

The server assigns contextual attributes to the cleaned records. The server takes, as input, the cleaned records and configuration data such as equipment-to-line mappings, production schedules, and location identifiers stored in configuration tables. The server joins the cleaned records with the configuration data to attach attributes including line identifier, product type, shift identifier, and physical location. The server writes the resulting enriched records into an intermediate table. The output of this step is a set of context-enriched records that link raw sensor values to specific operational entities.

### Step 4:

The server aggregates the context-enriched records into analysis data. The server uses, as input, the enriched records for each equipment and time range. The server groups records into fixed-length time windows, for example 1-minute or 5-minute intervals, using the normalized timestamps. Within each window, the server computes aggregation metrics such as count, mean, standard deviation, minimum, maximum, and cumulative throughput. The server stores each aggregated window as a row in an analysis-data table, keyed by equipment identifier and window start time. The output of this step is a compact analysis dataset that summarizes raw measurements in a form suitable for efficient computation.

### Step 5:

The server prepares feature vectors for machine learning analysis. The server reads, as input, multiple consecutive rows from the analysis-data table corresponding to a sliding time window for each equipment. The server orders the rows by time and constructs feature sequences by stacking performance indices and sensor statistics into multi-dimensional arrays. The server applies feature scaling by subtracting precomputed means and dividing by standard deviations for each feature dimension. The server writes the scaled feature sequences into a temporary feature buffer in memory. The output of this step is a set of normalized feature sequences ready to be passed to a machine learning model.

### Step 6:

The server executes a prediction model on the feature sequences. The server takes, as input, the normalized feature sequences from the feature buffer. The server loads a trained neural network model, such as an LSTM-based time-series predictor, from the storage device and initializes the model parameters in memory. The server performs forward propagation on each feature sequence, executing matrix multiplications and non-linear activations according to the model architecture. The server computes predicted future values of performance indices for one or more future time steps. The output of this step is a set of prediction results containing predicted throughput, defect rate, or other indices per equipment and future time interval.

### Step 7:

The server computes anomaly scores and detection results. The server receives, as input, both the prediction results and the corresponding actual observed analysis data for the same future intervals, when such data becomes available. The server calculates residuals by subtracting predicted values from actual values for each performance index. The server then squares and weights these residuals, sums them over the prediction horizon, and normalizes by the number of data points to compute an anomaly score. The server compares the anomaly score with a threshold stored in a configuration table and sets a detection flag if the score exceeds the threshold. The output of this step is a set of detection results containing anomaly scores and flags for each time window and equipment.

### Step 8:

The server derives evaluation indices and event records. The server uses, as input, the prediction results, detection results, and target performance settings, such as desired throughput or maximum acceptable defect rate. The server calculates evaluation indices including a risk score representing the likelihood and impact of future deviations and an efficiency-degradation index representing expected performance shortfalls relative to the target. When an evaluation index exceeds a configured limit, the server creates an event record containing the time, equipment identifier, type of event, and associated indices. The server stores these event records in an event table with appropriate indexing. The output of this step is a structured set of event records and evaluation indices accessible for further processing.

### Step 9:

The server constructs report data for visualization. The server reads, as input, analysis data, prediction results, and event records for a specified period and set of equipment. The server selects relevant series, such as actual throughput, predicted throughput, risk scores, and anomaly flags, and organizes them into data arrays segmented by time. The server associates each series with labels, units, and color codes. The server then creates report descriptors that specify which charts (for example, line charts for time series, bar charts for event counts) should be rendered and which data arrays each chart should use. The output of this step is a report-data structure containing both numerical arrays and visualization metadata.

### Step 10:

The terminal requests visualization from the server. The terminal receives, as input from the user, a selection of a time range, equipment group, or analysis mode through a graphical user interface. The terminal packages these selections as request parameters and sends an HTTP or other protocol request to the server, specifying a report endpoint and including the parameters. The terminal does not perform heavy computation but simply forwards the user's filtering criteria. The output of this step is a parameterized request delivered to the server that identifies which report data is needed.

### Step 11:

The server generates and transmits visualization information. The server takes, as input, the request parameters from the terminal and the previously constructed report data from the report-data structure. The server filters the report data to include only the requested time range and equipment, serializes the relevant data arrays and metadata into a transfer format, and embeds them into a view definition such as a markup document with chart configuration. The server sends this view definition back to the terminal via the communication network. The output of this step is visualization information suitable for rendering charts and tables on the terminal.

### Step 12:

The terminal renders the visualization and accepts further user interaction. The terminal receives, as input, the visualization information from the server. The terminal's rendering engine parses the view definition, allocates drawing surfaces, and plots time-series lines, bars, and markers according to the provided data arrays and chart metadata. The terminal displays the resulting charts on the screen and activates interactive elements such as tooltips and selection controls. The terminal outputs a visual representation that the user can inspect and interact with.

### Step 13:

The user inspects the visualization and initiates optimization. The user takes, as input, the displayed charts and event markers on the terminal screen. The user identifies, for example, an efficiency-degradation interval or repeated anomaly events. The user then selects an option, such as a button labeled “Generate Optimization Proposal,” and, if desired, enters additional text describing constraints or objectives. The output of this step is a user request, possibly including custom text, instructing the system to generate optimization proposals.

### Step 14:

The terminal sends an optimization request and optional custom prompt text to the server. The terminal receives, as input, the user's activation of the optimization feature and any typed text. The terminal constructs a request payload that includes context parameters (for example, selected time range, equipment identifiers, and event identifiers) and the user's custom text, if any. The terminal transmits this payload to the server over the communication network using an application protocol. The output of this step is a structured request at the server side that triggers prompt construction.

### Step 15:

The server compiles summary information for prompt construction. The server uses, as input, the optimization request parameters and the data stored in the analysis-data table and event table for the specified context. The server computes summary statistics such as average throughput, standard deviation, maximum anomaly score, frequency of specific event types, and typical efficiency-degradation intervals. The server also retrieves operating conditions and constraint conditions, such as maximum shift length or machine capacity limits, from configuration tables. The server organizes this summary information into a textual form and an internal representation. The output of this step is a structured data summary describing the recent system behavior in a compact format.

### Step 16:

The server generates a prompt sentence for the generative AI model. The server takes, as input, the textual summary information and system-level instructions. The server constructs a prompt sentence by concatenating a role description, the summarized statistics, identified anomaly-occurrence intervals, and explicit instructions for the generative AI model to produce proposals. The server ensures that the prompt sentence includes performance indices, operating conditions, and constraint conditions relevant to the requested optimization. For example, the server may produce a prompt sentence such as: “The server has collected and preprocessed the last 1 month of production data, including throughput, defect rate, and downtime per line. Analyze this summarized data and generate concrete proposals to optimize efficiency, focusing on improving throughput during the 14:00-16:00 time window on Line A under the constraint that total labor hours do not increase.” The output of this step is a complete prompt sentence ready to be sent to the generative AI model.

### Step 17:

The server calls the generative AI model with the prompt sentence. The server receives, as input, the constructed prompt sentence. The server converts the prompt sentence into a tokenized representation using a tokenizer consistent with the generative AI model, forms a request body including the token sequence and inference parameters such as maximum response length and sampling temperature, and sends the request to a model-serving endpoint over the communication network. The server waits for the model to compute and returns a natural-language response. The output of this step is a generated text sequence containing proposal information.

### Step 18:

The server parses and structures the proposal information. The server uses, as input, the natural-language response from the generative AI model. The server applies text processing rules, such as splitting the response into lines or paragraphs, detecting list markers, and recognizing keywords indicating proposal types (for example, “schedule change,” “maintenance,” “staffing”). The server converts each identified proposal item into a structured proposal record with fields for category, description, and any numerical estimates mentioned in the text. The server stores these proposal records in a proposal table in the storage device, along with a reference to the originating prompt sentence and analysis context. The output of this step is a set of structured proposals ready for presentation and logging.

### Step 19:

The server returns the structured proposals to the terminal. The server takes, as input, the proposal records from the proposal table that are associated with the current user request. The server formats the proposals into a response document or message that includes headings, categorical grouping, and plain-text descriptions. The server transmits this response to the terminal via the communication network. The output of this step is a proposals payload carrying the generated optimization recommendations to the client side.

### Step 20:

The terminal displays the proposals and collects user feedback. The terminal receives, as input, the proposals payload from the server. The terminal renders each proposal item in a dedicated area of the user interface, optionally aligned with corresponding charts or event markers. The terminal adds controls such as checkboxes or buttons labeled “Accept” and “Reject” and a text area for comments. The terminal outputs an interactive proposals view, enabling the user to review each recommendation and provide feedback.

### Step 21:

The user reviews, evaluates, and responds to the proposals. The user reads, as input, the displayed proposal items and their associated context on the terminal screen. The user decides, for each proposal, whether to accept it, reject it, or defer it, and optionally enters comments or adjustments. The user then confirms these choices using the interface controls. The output of this step is a set of user decisions and comments associated with specific proposal identifiers.

### Step 22:

The terminal transmits user decisions and comments to the server. The terminal takes, as input, the user's selections and typed comments from the proposals view. The terminal bundles these into a feedback payload containing proposal identifiers, acceptance or rejection flags, and comment text. The terminal sends this payload to the server through the communication network. The output of this step is a structured feedback request received by the server.

### Step 23:

The server records feedback and updates internal data structures. The server receives, as input, the feedback payload containing user decisions and comments. The server updates the corresponding proposal records in the proposal table by setting status fields (for example, “accepted” or “rejected”) and storing any comment text. The server may also log the feedback in a separate table used for analyzing the effectiveness of different prompt patterns and model configurations. The output of this step is an updated set of proposal records and feedback logs that can be used in subsequent optimization cycles.

### Step 24:

The server optionally adjusts future analysis and prompt construction based on feedback. The server uses, as input, historical feedback records and associated proposal content. The server computes, for example, acceptance rates by proposal category and correlates these with specific prompt structures or summary features. The server may update internal rules for prompt sentence generation, such as prioritizing proposal types with high acceptance rates or including additional context that was frequently requested by users. The server stores revised configuration parameters that influence how future prompt sentences are assembled. The output of this step is an updated configuration that refines the behavior of the system, improving the relevance and efficiency of subsequent generative AI model interactions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional business analysis systems require human experts to manually configure data preprocessing pipelines, select appropriate analytical models, and design visualizations for each analysis scenario. In many deployments, a server simply executes a fixed sequence of scripts that assume predefined data formats and static business logic. When a user wishes to change the prediction horizon, the comparison baseline, or the type of analysis, the user or an administrator must modify configuration files, rewrite query logic, or reimplement model code. This rigid architecture causes significant latency between a business question and the generation of a corresponding analytical result, and it often leads to underutilization of available data and computational resources.

Furthermore, existing systems that incorporate machine learning models for forecasting or clustering typically lack a robust interface layer that interprets users' natural language requests in a way that is directly mapped to executable analytical operations. Natural language input, if supported at all, is frequently processed in an ad hoc manner by simple keyword matching or rule-based parsers. These approaches are not able to adequately capture complex, multi-step analytical intents such as “forecast the next 12 months, compare with the same months last year, identify periods of decline, and relate them to expense clusters,” and they cannot adapt the underlying computational graph dynamically in response to such requests.

From a computer-technology perspective, this results in suboptimal use of computing infrastructure on the server side: prediction models and clustering models are not orchestrated in an integrated way according to user intent; preprocessed datasets are not reused or recombined efficiently; and visualization outputs are not systematically aligned with the computed analytical semantics. The processing pipeline remains fragmented, and significant manual intervention is required to bridge the gap between user questions and machine-executable instructions.

In addition, conventional generative artificial intelligence components, when present, are often used only to generate textual summaries after the data analysis has already been completed by a separate static pipeline. They are not used as a central orchestration mechanism that transforms a prompt sentence into machine-readable instruction data specifying which datasets to use, which models to run, how to set prediction parameters, and how to structure the outputs. As a result, the generative artificial intelligence model does not improve the underlying computing process itself, but merely decorates the outputs with narrative text.

Therefore, there is a need for a technical mechanism on the server side that integrates structured data ingestion, automated preprocessing, predictive modeling, clustering, and visualization generation with a generative artificial intelligence model that interprets prompt sentences and produces machine-readable instructions. Such a mechanism should dynamically control model selection, parameterization, comparison logic, and highlighting logic, thereby improving the flexibility, throughput, and responsiveness of the business analysis system as a whole. It is particularly desirable to realize an improved server configuration in which the generative artificial intelligence model acts as a controller for the analytical pipeline, so that the server can automatically translate natural language requests into concrete data transformations and model executions, without requiring human intervention in the underlying program logic.

The specific processing by the specific processing unit 290 of the data processing device 12 in Example 2 is realized by the following means.

The present invention provides a server comprising a processor and a memory storing instructions which, when executed by the processor, cause the server to receive structured data including business-related historical data from a terminal, to load the structured data into a tabular data structure, to perform preprocessing including completion of missing values, conversion of data types, aggregation based on time information, and generation of feature values to generate a preprocessed dataset, to construct, by applying statistical processing and machine learning processing to the preprocessed dataset, a prediction model for predicting future business indicators and a clustering model for classifying expense characteristics, to calculate future values and cluster information using the prediction model and the clustering model, to generate a structured output including predicted values for future time points, comparative indicators, and aggregated values per cluster and to transmit the structured output to the terminal, to receive from the terminal a prompt sentence in natural language together with context information relating to the structured data or the preprocessed dataset, to provide the prompt sentence and constraint information indicating available data sets, available analysis operation types, and a required output format to a generative artificial intelligence model, to obtain from the generative artificial intelligence model machine-readable instruction data including at least a task type, a prediction period, a comparison criterion, a visualization requirement, and an explanation requirement, to interpret the instruction data as analysis instruction information including data selection, prediction target period, comparison condition, output format, and explanation style, to select or reconstruct, based on the analysis instruction information, at least one of the prediction model and the clustering model, to execute the selected models to identify future values, comparison results, and time points at which an anomaly or a risk is expected, to associate the future values with past actual values for corresponding periods based on time information and to calculate differences or ratios of values in a same cycle, to automatically extract, based on the calculated differences or ratios and the instruction data, periods in which a business risk or a business opportunity is expected, to generate a summary explanation of identified results, and to transmit analysis result data including the future values, the comparison results, the extracted periods, and the summary explanation to the terminal. This enables the server to computationally improve the end-to-end analytical pipeline by using the generative artificial intelligence model as a controller that converts natural language prompt sentences into executable instructions for data preprocessing, model execution, comparison logic, and visualization control, thereby reducing manual configuration, increasing adaptability to diverse analytical requests, and enhancing the efficiency and responsiveness of computer resources in generating business forecasts and risk or opportunity indications.

The term “system” refers to an arrangement of at least one server and at least one terminal interconnected by a communication network and configured to execute the processes described in the claims.

The term “processor” refers to a hardware processing unit, such as a central processing unit or other general-purpose or specialized computation unit, that executes instructions stored in a memory to perform data processing operations.

The term “terminal” refers to an information processing apparatus, such as a client computer, a mobile device, or another user interface device, that interacts with a user and communicates with the server via a communication network.

The term “server” refers to an information processing apparatus, including at least one processor and a memory, that receives data and requests from the terminal, executes analytical and control processes, and returns results to the terminal.

The term “communication network” refers to a wired or wireless communication infrastructure, including local networks, wide-area networks, or public networks, through which the terminal and the server exchange data.

The term “structured data” refers to data organized in a predefined format, such as rows and columns in a table, where each column represents a field and each row represents a record, and where the data can be parsed and processed programmatically.

The term “business-related historical data” refers to past records associated with business activities, including but not limited to sales data, expense data, revenue data, cost data, or other financial or operational metrics.

The term “tabular data structure” refers to a data structure in which data is arranged in a table-like format of records and fields, such as an in-memory table, an array of records, or a data frame.

The term “preprocessing” refers to computational operations applied to raw structured data prior to analytical processing, including but not limited to completion of missing values, conversion of data types, aggregation, normalization, and feature generation.

The term “completion of missing values” refers to a process of detecting absent or null values in the structured data and replacing such values with substitute values determined by predetermined rules or statistical methods.

The term “conversion of data types” refers to transforming values in one representation, such as a character string, into another representation, such as a numeric type or date-time type, that is suitable for further computation.

The term “aggregation based on time information” refers to combining multiple records according to temporal attributes, such as date or time, to compute summarized values per period, including sums, averages, or other aggregate functions.

The term “generation of feature values” refers to deriving additional data attributes from existing data, such as computed indicators, moving averages, temporal encodings, or other constructed variables used as input to analytical models.

The term “preprocessed dataset” refers to a dataset obtained after application of preprocessing operations to structured data, and which is suitable for input to analytical or predictive models.

The term “statistical processing” refers to analytical operations based on statistical techniques, including descriptive statistics, regression analysis, time-series analysis, and related computational methods.

The term “machine learning processing” refers to computational processes that train and apply models using data-driven algorithms, including but not limited to regression models, classification models, and clustering models.

The term “prediction model” refers to a trained computational model that receives input features and outputs estimates of future or unknown values of one or more target variables. The term “clustering model” refers to a trained computational model that assigns input records to groups or clusters based on similarity or distance measures in a feature space. The term “expense characteristics” refers to attributes of expense data, including amount, category, department, period, or other features that describe expenses and can be used for classification or grouping.

The term “future values” refers to predicted values of business indicators for time points that occur after the latest time point included in the business-related historical data.

The term “cluster information” refers to data representing the assignment of records to clusters and summary statistics of such clusters, including cluster identifiers, aggregated values, and descriptive attributes.

The term “structured output” refers to machine-readable data generated by the server that organizes analysis results, including predicted values, comparative indicators, and cluster summaries, in a predefined format such as a structured record or a data object.

The term “comparative indicators” refers to values that express differences, ratios, or other relationships between predicted values and baseline values, such as past actual values or averaged historical values.

The term “visual display” refers to an output rendered on a display device of the terminal, including graphical and textual elements that present the structured output or analysis result data to the user.

The term “graph indicating time-series transitions” refers to a graphical representation, such as a line chart or bar chart, that displays values of one or more indicators over time.

The term “table indicating classification results” refers to a tabular representation in which rows or columns correspond to clusters or categories, and in which classification-related values or aggregated statistics are shown.

The term “highlighted display” refers to a visual representation in which particular elements, such as certain time points or clusters, are distinguished by visual emphasis, including color changes, markers, or annotations.

The term “prompt sentence” refers to a natural language expression input by the user to request an analysis, specify a task, or define conditions for data processing and visualization. The term “context information” refers to metadata or parameters associated with the structured data or the preprocessed dataset, including identifiers of datasets, time ranges, model states, or prior analysis settings.

The term “generative artificial intelligence model” refers to a computational model, typically implemented as a neural network, that generates text or structured outputs based on input text and optional control information, and that is capable of interpreting prompt sentences and producing machine-readable instructions.

The term “constraint information” refers to data that specifies limits, options, or rules for processing by the generative artificial intelligence model, including available datasets, permissible analysis operation types, and required output formats.

The term “machine-readable instruction data” refers to structured data generated by the generative artificial intelligence model, such as a record or data object, that specifies one or more tasks, parameters, or conditions in a format suitable for direct interpretation by a program.

The term “task type” refers to a classification of an analytical operation, including but not limited to forecasting, clustering, comparison, or visualization-oriented tasks.

The term “prediction period” refers to a range or number of future time points for which the prediction model is to produce future values.

The term “comparison criterion” refers to a rule or baseline by which predicted values are compared with other values, such as values of the same period in a previous year or an historical average.

The term “visualization requirement” refers to one or more conditions specifying how results are to be graphically or textually displayed, including chart types, highlighting rules, and layout parameters.

The term “explanation requirement” refers to one or more conditions specifying the style, depth, or structure of a natural language explanation to be generated for analysis results. The term “analysis instruction information” refers to an interpreted form of the machine-readable instruction data, representing concrete processing directives for data selection, prediction target period, comparison conditions, output formats, and explanation styles.

The term “select or reconstruct the prediction model and the clustering model” refers to a process in which existing models are chosen for reuse, or new models are created or retrained with different parameters or datasets, in response to the analysis instruction information.

The term “time points at which an anomaly or a risk is expected” refers to specific periods in a time series where computed indicators or comparison results satisfy conditions suggesting abnormal behavior or potential adverse or notable business events.

The term “summary explanation” refers to a natural language description that concisely characterizes the analysis results, including key trends, risks, opportunities, and notable patterns.

The term “analysis result data” refers to a data structure containing numerical results, identified periods, cluster-related information, and one or more summary explanations, which is transmitted from the server to the terminal for presentation to the user.

The term “associate future values with past actual values” refers to a computational operation that aligns predicted values with corresponding historical values based on shared time indices or equivalent temporal attributes.

The term “differences or ratios of values in a same cycle” refers to numerical measures derived by subtracting or dividing values of the same or corresponding time periods across different years or cycles, enabling cyclical or seasonally adjusted comparison.

The term “periods in which a business risk or a business opportunity is expected” refers to one or more time ranges identified based on differences or ratios and other criteria as being likely to involve adverse conditions, such as decreased performance, or favorable conditions, such as increased growth.

In one embodiment, a server executes a program that implements the claimed system in cooperation with at least one terminal operated by a user. The server includes at least one processor, a main memory, a non-transitory storage device, and a network interface connected to a communication network. The terminal includes at least one processor, a display, an input device, a local storage device, and a network interface. The user operates the terminal to supply business-related historical data and prompt sentences to the server, and the server executes analytical processing and returns visualized results.

The server uses a general-purpose operating system, such as a server operating system for multiprocessor machines, and a runtime environment, such as an interpreter or virtual machine for a high-level programming language. In one example, the server uses a Python runtime executing software libraries for data analysis and machine learning. The server uses a data analysis library, such as a table-oriented library implementing data frame structures, to load and transform structured data. The server uses a machine learning library implementing regression and clustering algorithms to construct and apply prediction models and clustering models. The server uses a communication library, such as an HTTP framework, to receive data and prompt sentences from the terminal and to transmit analysis results to the terminal. The terminal runs a client application, which may be a web browser displaying a web-based user interface or a native mobile application. The terminal presents file selection dialogs and text input fields on the display. The user uses the input device to select data files stored in the local storage device and to enter prompt sentences in natural language. The terminal sends structured data and prompt sentences to the server through the network interface by transmitting request messages to predefined server endpoints. The terminal receives structured outputs and analysis result data from the server and renders graphs and tables using a graphical user interface framework. The terminal may employ a charting library to draw time-series graphs and tables that visually indicate classification results and highlight specific time points or clusters.

The server loads business-related historical data, such as sales records and expense records, from files or database entries into tabular data structures. Each table includes a time field, one or more numerical fields, and optional categorical fields. The server uses a data frame library to represent this data as in-memory tables with row and column indices. The server performs preprocessing operations including completion of missing values, conversion of data types, aggregation based on time information, and generation of additional feature values. For example, the server detects missing numerical values in the data frames and replaces them using statistical estimates such as mean or median values, or using interpolation across time. The server converts textual date strings into date-time objects and converts currency-related values into floating point representations. The server aggregates daily records into monthly or quarterly records by summing or averaging values grouped by time periods. The server generates feature values such as moving averages over sliding windows, encoded seasonal indicators (e.g., month-of-year or quarter-of-year), and lag features representing prior-period values.

The server then constructs prediction models and clustering models using the machine learning library. For prediction of future business indicators, the server selects input features from the preprocessed dataset, such as previous period values, moving averages, seasonal indicators, and exogenous variables, and selects a target variable, such as future sales amounts. The server configures a regression model, for example, a linear regression model or a regularized linear model with parameters controlling regularization strength. The server trains the model by solving an optimization problem that minimizes a loss function, such as mean squared error, over the training data. The server uses gradient-based or closed-form methods provided by the machine learning library to update model parameters. The server can also use alternative architectures, such as tree-based ensemble models or shallow neural networks with one or more hidden layers. When shallow neural networks are used, the server configures weight matrices and bias vectors between layers and updates them using backpropagation and gradient descent with a learning rate parameter and an error function such as mean squared error.

For clustering of expense characteristics, the server uses a clustering algorithm that partitions the preprocessed feature vectors into groups. In one embodiment, the server uses a centroid-based clustering algorithm with a specified number of clusters. The server selects features such as normalized expense amounts, encoded categories, and temporal features, and applies a feature scaling procedure so that dimensions with large numeric ranges do not dominate the clustering distance measure. The server initializes cluster centroids and iteratively assigns data points to the nearest centroid according to a distance metric, such as Euclidean distance, and then recomputes the centroids until convergence. In alternative embodiments, the server can use density-based clustering or hierarchical clustering, with parameters such as minimum cluster size and distance thresholds. The server stores cluster labels for each record and calculates summary statistics per cluster, such as total expenses, average expenses, and variance, using group-by operations over the data frames.

The server generates structured outputs that combine prediction results and clustering results. For time-series prediction, the server creates a table of future time points and associated predicted values, optionally including confidence intervals derived from model variance or residual analysis. For clustering, the server summarizes each cluster with aggregated numeric indicators and representative categories. The server encodes these results as structured output data and transmits them to the terminal. The terminal renders the results as line graphs, bar charts, and tables. For example, the terminal draws a line graph of predicted monthly sales for the next year and a table showing clusters of expenses with aggregated amounts and labels. The terminal highlights particular graph points or table rows based on flags contained in the structured output.

The user uses the terminal to input prompt sentences in natural language that describe analysis requests. Examples of such prompt sentences include: “Based on the past 5 years of monthly sales data, please forecast the sales for the next 12 months and highlight months where sales are expected to drop below last year's value.” Another example is: “Cluster the last 3 years of expense data and identify clusters that show consistently increasing costs; then summarize them in plain English.” A further example is: “Compare the sales forecast for next year with the average of the last 3 years and generate an executive summary focusing on risks and growth opportunities.” The terminal sends the prompt sentence and context information, such as dataset identifiers and current visualization state, to the server.

The server uses a generative AI model to interpret the prompt sentence. In one embodiment, the server employs a large-scale neural network model implemented as a sequence-to-sequence transformer. The generative AI model includes an encoder and a decoder composed of multiple layers of self-attention and feedforward sub-layers. Each layer uses attention heads that compute weighted sums of token embeddings based on learned query, key, and value projections. The model is trained in advance on text corpora using a language modeling objective. Further training or fine-tuning may be performed on domain-specific prompts and corresponding instruction annotations, so that the model learns to output structured instruction data for business analysis tasks.

The server represents the prompt sentence as a sequence of tokens and supplies the tokenized sequence to the generative AI model together with constraint information. The constraint information indicates available datasets (for example, “sales data,” “expense data”), available analysis operations (for example, “forecast,” “cluster,” “compare,” “visualize”), and required output formats (for example, lists of key-value pairs specifying fields such as “task_type,” “horizon,” or “baseline”). The generative AI model processes this combined input and generates machine-readable instruction data that specifies at least a task type, prediction period, comparison criterion, visualization requirements, and explanation requirements. The server parses the output sequence into a structured internal representation, for example, a set of fields including “task_type=forecast_sales,” “horizon_months=12,” “compare_to=last_year_same_month,” “highlight_condition=decline,” and “explanation_style=executive_summary.”

The server interprets this instruction data as analysis instruction information and uses it to orchestrate subsequent processing. The server selects one or more preprocessed datasets according to the specified data selection, reuses or reconstructs prediction models and clustering models with parameters specified or implied by the instruction data, and configures comparison logic. For example, when the comparison criterion requires year-over-year comparison, the server aligns predicted values for future months with actual values from the same calendar months in a prior year using time indices. The server computes differences or ratios between predicted and historical values and flags time points where the difference satisfies a condition, such as a negative threshold. Because the instruction data is detailed and machine-readable, the server can compose a non-trivial analytical pipeline dynamically, without resorting to fixed, hard-coded workflows.

The server then prepares a compact numerical summary of the analysis, including predicted values, identified periods of risk or opportunity, and cluster-level statistics. The server supplies this summary, together with instructions about explanation style, to the generative AI model. The generative AI model generates a natural language summary explanation that describes the main findings in a manner appropriate for the specification, for example in concise executive-level language or in more technical detail. The server attaches this explanation to the analysis result data and sends the analysis result data to the terminal. The terminal receives the analysis result data and updates the visual display. The terminal renders the summary explanation in text form and visually emphasizes identified time points or clusters on the existing graphs and tables. For example, months with predicted declines may be highlighted in a contrasting color or annotated with icons, and clusters with increasing expense patterns may be highlighted with border effects or color changes. The user can iteratively refine the analysis by submitting further prompt sentences, such as “Please analyze which expense clusters are most related to the months with declining sales and suggest cost-control strategies.” The server again uses the generative AI model to interpret the new prompt sentence into instructions that specify combining time-series comparisons with cluster statistics.

The system produces technical effects within the computing environment that go beyond merely automating a human analyst's workflow. The server reduces processing latency and improves throughput by separating reusable preprocessed datasets and reusable trained models from dynamic instruction interpretation. The generative AI model does not only generate explanatory text but also acts as a controller that produces compact machine-readable commands. This reduces the amount of control data that must be sent from the terminal to the server and enables the server to reconfigure its model execution and comparison logic without restarting services or modifying code, thereby reducing communication overhead and administrative overhead. Because the instruction data explicitly encodes prediction horizon, comparison criterion, and visualization requirements, the server can avoid redundant computations by caching intermediate results and reusing feature matrices and model states. This yields improvements in computation efficiency and reduces memory usage.

The generative AI model is configured in a non-conventional way relative to typical use as a pure text generator. The server constrains the output space to structured instruction fields and trains or fine-tunes the model to generate structured command sequences. The server additionally applies validation rules to the instruction data, such as checking that requested datasets exist, that time ranges overlap with available data, and that requested combinations of tasks are supported. In case of ambiguity, the server may generate a clarification request or adjust parameters according to predefined preferences. This combination of a constrained generative model and rule-based validation allows the server to systematically transform unstructured prompt sentences into deterministic analytical procedures. The technical improvement lies in the automated synthesis of executable, composable analytical plans from natural language, which is not achievable by simple keyword-based routing.

The data structures in the system are specifically designed to support this improvement. The server stores preprocessed datasets in a normalized table format with standardized time indices and feature vectors. The server maintains an index of available models, annotated with supported feature sets, training ranges, and performance metrics. The instruction data produced by the generative AI model references these indices and identifiers, enabling the server to map abstract analysis requests to concrete models and datasets through efficient lookup operations. By structuring data and model metadata in this way, the server reduces search time for suitable models and reduces the risk of invoking incompatible models, thereby improving accuracy and stability of predictions.

In some embodiments, the server implements a modular architecture in which the generative AI interpretation module, the data preprocessing module, the model execution module, and the visualization preparation module are separated but interconnected by standardized interfaces. The modules exchange data structures defined by schemas, and the generative AI interpretation module outputs instruction data that conforms to a command schema. Alternative embodiments may use different machine learning algorithms, such as recurrent neural networks for time-series forecasting or probabilistic models for uncertainty estimation. Alternative generative AI architectures can be used, such as encoder-decoder networks with attention or transformer-based decoders with different numbers of layers, attention heads, and embedding dimensions. The connections and parameters of these models can be adjusted according to computational resources and desired accuracy.

The server can also be configured to perform distributed processing across multiple processor cores or multiple machines. Preprocessing operations on large datasets can be parallelized by partitioning the data according to time or entity identifiers. The generative AI model can be executed on specialized hardware, such as graphics processing units or tensor processing units, to accelerate inference time when interpreting prompt sentences and generating instruction data. These architectural choices yield further technical effects including reduced runtime for complex analyses, improved scalability when handling larger data volumes, and reduced server response time from the user's perspective.

In summary, the server, the terminal, and the user cooperate in a system in which the generative AI model produces structured instruction data that orchestrates the server's data preprocessing, model execution, and comparison logic. This configuration improves the operation of the computer system itself by enabling dynamic analytical pipelines, efficient reuse of models and data, reduced manual configuration, and faster and more accurate alignment between user intent and computational processing.

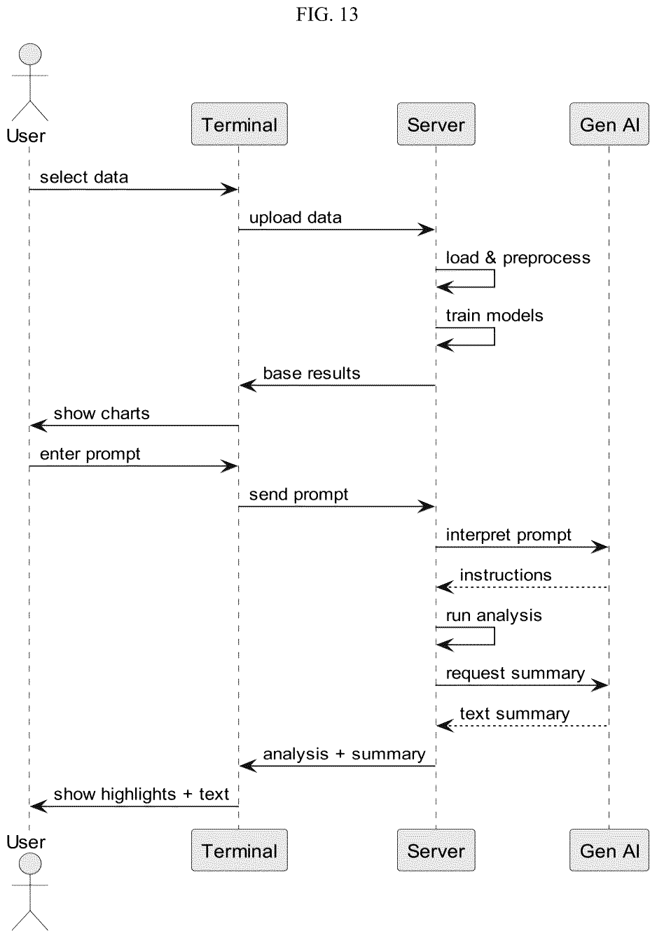

The following describes the processing flow using FIG. 13.

### Step 1:

The user operates the terminal to select business-related historical data stored in a local storage device and to initiate transmission to the server. The input of Step 1 is raw business data files, such as CSV files containing sales records and expense records. The terminal displays a file selection dialog, reads the selected files, and packages them into a request message. The terminal transmits the files together with metadata, such as dataset type and date range, to the server over a communication network. The output of Step 1 is a network request containing the raw structured data sent from the terminal to the server.

### Step 2:

The server receives the network request from the terminal and stores the uploaded files into a temporary storage area. The input of Step 2 is the transmitted raw structured data and associated metadata. The server uses a data analysis library to load each file into an in-memory tabular data structure, such as a data frame with rows and columns. The server validates the schema by checking that required columns like time, value, and category exist, and it records dataset identifiers and schema information in metadata storage. The output of Step 2 is one or more validated data frames representing the raw structured data and corresponding dataset metadata stored on the server.

### Step 3:

The server performs preprocessing on the loaded data frames to generate a preprocessed dataset suitable for analysis. The input of Step 3 is the set of raw data frames and their metadata. The server detects missing values by scanning each column for null or invalid entries and calculates replacement values such as means, medians, or interpolated values along the time dimension. The server converts column data types, for example, converting date strings to internal date-time objects and converting numeric strings to floating point numbers. The server aggregates records by time units, such as summing daily values into monthly totals, by grouping on the time fields. The server also generates feature values, such as moving averages over specified windows, seasonal indicators derived from the date (e.g., month index), and lagged values representing prior periods. These data manipulations transform the original raw data into feature vectors that can be directly fed into analytical models. The output of Step 3 is a set of preprocessed data frames containing cleaned, typed, aggregated, and feature-augmented records.

### Step 4:

The server trains or updates prediction models using the preprocessed dataset. The input of Step 4 is the preprocessed data frames and model configuration parameters, such as target variables, feature sets, and training ranges. The server selects columns representing input features, such as past values, moving averages, and seasonal indicators, and selects a target column representing the quantity to be predicted, such as future sales. The server divides the data into training and validation subsets based on time or random splits. The server feeds the training features and targets into a regression algorithm, such as a linear regression or regularized regression algorithm, and computes model parameters by minimizing a loss function, for example, mean squared error. When a neural network is used, the server initializes weight matrices and iteratively updates them using backpropagation and gradient descent based on calculated prediction errors. The server evaluates the model on the validation subset to compute error metrics and stores both the trained model parameters and performance metrics. The output of Step 4 is at least one trained prediction model associated with the corresponding dataset and feature schema.

### Step 5:

The server constructs clustering models to classify expense characteristics. The input of Step 5 is the portion of the preprocessed data frames that contains expense-related features and the clustering configuration parameters, such as the number of clusters. The server selects relevant columns, such as normalized expense amounts, encoded categories, and time-derived features, and performs feature scaling so that each dimension has comparable magnitude. The server applies a clustering algorithm, such as a centroid-based method, which iteratively assigns each record to the nearest cluster center using a distance metric and then recalculates centers until convergence. The server attaches cluster labels to each record by adding a cluster identifier column to the data frame. The server computes aggregated statistics for each cluster, such as total expenses, average expenses, and counts, by grouping on the cluster identifier and applying aggregation functions. The output of Step 5 is a trained clustering model, a labeled expense dataset, and cluster-level summary statistics.

### Step 6:

The server generates baseline analytical outputs from the trained models. The input of Step 6 is the trained prediction model, the trained clustering model, and the preprocessed data frames. The server constructs a series of future time points for a default prediction horizon, such as the next 12 months, and builds feature vectors for these future periods by extrapolating seasonal indicators and using recent historical data for lag features. The server inputs these feature vectors into the prediction model to compute predicted values for each future time point. The server organizes the prediction results and cluster summaries into a structured output format, including predicted values, time indices, comparative baselines if available, and aggregated cluster metrics. The server transmits the structured output to the terminal. The output of Step 6 is structured result data that can be directly visualized by the terminal.

### Step 7:

The terminal receives the structured result data from the server and generates a visual display. The input of Step 7 is the structured output containing time-series predictions and cluster summaries. The terminal parses the structured fields and creates visual components, such as line charts for predicted values and tables for cluster statistics. The terminal maps each time point to the horizontal axis and predicted values to the vertical axis for graphs, and fills table cells with cluster identifiers and aggregated metrics. The terminal renders these graphical and tabular elements on the display, optionally applying default emphasis such as different colors for different clusters. The output of Step 7 is a rendered user interface showing graphs and tables that represent the initial analysis results.

### Step 8:

The user observes the displayed results on the terminal and formulates a prompt sentence in natural language to request a specific analysis. The input of Step 8 is the visual information displayed on the terminal and the user's analytical intent. The user types a prompt sentence into a text input field provided by the terminal. Example prompt sentences include: “Based on the past 5 years of monthly sales data, please forecast the sales for the next 12 months and highlight months where sales are expected to drop below last year's value.” Another example is: “Cluster the last 3 years of expense data and identify clusters that show consistently increasing costs; then summarize them in plain English.” A further example is: “Compare the sales forecast for next year with the average of the last 3 years and generate an executive summary focusing on risks and growth opportunities.” The terminal captures the prompt sentence and current context identifiers, such as selected datasets. The terminal transmits the prompt sentence and context information to the server. The output of Step 8 is a network request containing the prompt sentence and context data.

### Step 9:

The server interprets the prompt sentence using a generative AI model. The input of Step 9 is the prompt sentence, the context information about available datasets and models, and constraint information defining allowed operations and required output formats. The server tokenizes the prompt sentence and passes the token sequence and constraint signals into a generative AI model, such as a transformer-based sequence model configured to produce structured instruction fields. The model processes the input and outputs a sequence encoding a task type, a prediction period, a comparison criterion, visualization requirements, and explanation requirements. The server decodes this sequence into an internal instruction object with fields such as data selection, prediction horizon, and highlight conditions. This process transforms unstructured text into structured commands. The output of Step 9 is analysis instruction information that specifies which datasets and models to use, how long to predict, how to compare, and how to visualize and explain the results.

### Step 10:

The server executes analytical computations in accordance with the analysis instruction information. The input of Step 10 is the instruction information, the preprocessed datasets, and the trained models. The server selects the relevant dataset, for example, the sales dataset, and constructs feature matrices for the requested prediction period, such as 12 future months. The server runs the specified prediction model on these features to obtain predicted values. The server retrieves historical values for comparison baselines, such as the same months in the previous year or multi-year averages, and aligns them with the predicted values by matching time indices. The server calculates numerical comparison measures, such as differences or ratios between predicted and baseline values, and identifies time points that satisfy specific conditions, such as predicted values falling below baseline. If clustering-related instructions are present, the server computes correlations or relationships between identified periods and clusters by aggregating expense data for those periods by cluster. The output of Step 10 is an intermediate analysis result set that includes predicted values, comparison values, flags for critical time points, and any derived metrics relating to clusters.

### Step 11:

The server prepares a numerical summary and obtains a natural language explanation using the generative AI model. The input of Step 11 is the intermediate analysis result set and explanation requirements contained in the instruction information. The server condenses the intermediate results into structured summary data, such as lists of key time points with declines, overall growth percentages, and cluster-level risk or opportunity indicators. The server then provides the summary data and an instruction specifying explanation style to the generative AI model. The generative AI model encodes the summary data into an internal representation and decodes it into a natural language text that explains the main findings, such as trends, risks, and opportunities. The server receives this generated explanation and attaches it to the numerical results and visualization directives. The output of Step 11 is final analysis result data containing numerical outputs, identified time points, cluster insights, and a summary explanation in natural language.

### Step 12:

The terminal receives and presents the final analysis result data to the user. The input of Step 12 is the final analysis result data transmitted from the server. The terminal updates existing graphs by applying highlight rules to time points or clusters flagged in the result data, for example, by changing colors or adding markers to certain data points. The terminal displays the generated summary explanation as a text block in proximity to the graphs and tables, enabling the user to understand the numerical results with contextual descriptions. The terminal allows the user to interact with highlighted elements, such as hovering over or tapping on points to view detailed tooltips. The output of Step 12 is an updated user interface that visually and textually conveys the dynamically generated analysis in a form driven by the user's prompt sentence.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional business analysis systems typically ingest structured data from databases, apply batch statistical processing, and display static dashboards. Such systems suffer from several technical limitations in the context of modern, interactive, data-intensive computing environments.

First, existing systems are not designed to dynamically integrate heterogeneous information sources, including external information sources and internal operational databases, in response to user-level natural language instructions. In many implementations, information retrieval pipelines and model-execution pipelines are statically configured in advance. As a result, the computing resources that perform data acquisition, normalization, and storage must be manually reconfigured whenever the information need changes, which introduces latency and increases processor load and memory usage due to redundant or unnecessary data flows. Second, conventional systems typically treat user interaction as a simple input/output channel and do not exploit signals such as user emotional state as parameters for controlling core computational behavior. Alert generation and prioritization are commonly implemented as fixed threshold rules independent of any user context. Consequently, processors may waste cycles generating and transmitting large volumes of low-priority alerts, while high-priority alerts are not adaptively surfaced to the user. The resulting notification overload degrades the effectiveness of the user interface and can increase the time and number of operations required for the user to identify truly critical information.

Third, in many computing environments predictive models and optimization engines are executed as opaque components. When forecast accuracy degrades, conventional systems either continue to use stale models or require manual engineering effort to diagnose model drift and perform retraining. The processor therefore cannot autonomously monitor deviations between predictions and realized outcomes, cannot automatically schedule retraining based on objective criteria, and cannot efficiently update internal models without manual intervention. Moreover, when models are updated, existing systems do not automatically generate machine-readable explanations that can be reused to adapt downstream logic or to support human understanding.

Fourth, existing decision-support systems rarely integrate generative artificial intelligence models in a structured, system-level manner. Where such models are used, they are often treated as separate tools, manually operated by the user. The processor is not configured to automatically construct rich, machine-generated prompt sentences that encapsulate internal numerical state, predictions, optimization results, and user context, and then feed these prompt sentences into a generative model as part of a closed-loop computation. This separation leads to inefficient data handling, duplicated computations, and inconsistent decision artifacts.

Accordingly, there is a need for an improved computer-implemented system that (i) programmatically transforms user prompt sentences into dynamic, multi-source data acquisition and structuring operations, (ii) performs end-to-end analysis, prediction, and optimization while treating user emotional state as a first-class control parameter for alert prioritization and strategy selection, and (iii) automatically generates and consumes structured prompt sentences for a generative artificial intelligence model in order to produce strategy proposals and explanatory reports. By implementing these mechanisms at the processor and system level, the invention seeks to improve the efficiency, adaptability, and responsiveness of the underlying computing architecture, reduce unnecessary computational load, and enhance the relevance and usability of system outputs through technically grounded control of data flows, model management, and user-facing content generation.

The specific processing by the specific processing unit 290 of the data processing device 12 in Application Example 2 is realized by the following means.

The present invention provides a server comprising a processor and a memory storing instructions which, when executed by the processor, cause the server to receive a prompt sentence from a user terminal that specifies acquisition of related information, to automatically acquire related information from at least one external information source and at least one internal information source based on the prompt sentence, to convert the acquired information into a structured format, and to store the structured information in a storage device as an information collection; to analyze transactional information, cost information, inventory information, and production information stored in the information collection by performing preprocessing, statistical analysis, time-series analysis, and prediction using at least one machine learning algorithm, to calculate future business balance and demand, and to optimize inventory quantities and procurement plans; to analyze text information, audio information, and image information obtained from a user in order to estimate an emotional state of the user and to store the estimated emotional state in association with results of the prediction and the optimization; to generate context information for selecting an aggressive or conservative business strategy in accordance with the emotional state of the user while adjusting importance and presentation order of alert information based on the results of the prediction and the optimization and the emotional state; to generate a further prompt sentence including the context information, to input the further prompt sentence into a generative artificial intelligence model to cause the generative artificial intelligence model to generate a business-strategy proposal text and an explanatory text, and to generate a report including the proposal text, the explanatory text, numerical prediction results, and visualization information and present the report to the user terminal; and to monitor, in real time, business data and inventory data, to detect an abnormality by comparing the business data and the inventory data with the prediction results or with at least one threshold, and, when the abnormality is detected, to notify the user terminal of alert information whose priority has been adjusted based on the emotional state. This enables the computing system to automatically orchestrate multi-source data acquisition, model-based prediction and optimization, emotion-aware alert prioritization, and structured interaction with a generative artificial intelligence model as an integrated pipeline, thereby improving processor efficiency, reducing unnecessary data processing and notifications, dynamically adapting model behavior and content generation to user context, and enhancing the technical performance and responsiveness of the decision-support computing environment.

The term “system” refers to a combination of hardware and software components, including at least one processor, memory, storage device, communication interface, and program code, that cooperate to execute the processing described in the claims.

The term “processor” refers to a hardware computation unit, such as a central processing unit or an execution core, capable of executing machine-readable instructions to perform logical, arithmetic, control, and input/output operations.

The term “memory” refers to a volatile or non-volatile storage medium, such as a random access memory or a read-only memory, that stores program instructions and data used by the processor during execution.

The term “storage device” refers to a non-volatile information storage medium, such as a magnetic disk, a solid-state drive, or a network-accessible storage system, that persistently stores structured and unstructured data.

The term “user terminal” refers to an information processing apparatus, such as a personal computer, a smartphone, or a tablet device, that provides an interface through which a user can send input to the system and receive output from the system.

The term “prompt sentence” refers to a natural-language instruction or query input by a user or generated by the system, which specifies an information acquisition task, an analysis request, or a content-generation request to be executed by the system or by a generative artificial intelligence model.

The term “external information source” refers to a data provider outside the system, such as a remote database, a web service, or an information feed, from which the system acquires information via a communication network.

The term “internal information source” refers to a data repository or process within the system boundary, such as a local database, a log store, or an in-memory cache, from which the system acquires information without leaving the administrative domain of the system.

The term “structured format” refers to a representation of data in which fields and relationships are explicitly defined according to a schema, such as a table structure, a record structure, or a hierarchical document structure, enabling systematic storage and processing. The term “information collection” refers to a logical aggregation of structured data records stored in the storage device, including at least transactional information, cost information, inventory information, and production information, which are used for subsequent analysis and prediction.

The term “transactional information” refers to data representing discrete business events, such as sales, purchases, or financial entries, that include at least time, item, quantity, and value attributes.

The term “cost information” refers to data related to expenditures associated with business activities, including but not limited to logistics costs, labor costs, and overhead costs. The term “inventory information” refers to data representing quantities, locations, and statuses of items held in stock within a supply chain or facility.

The term “production information” refers to data representing operational states and outputs of production processes, including at least production volume, processing time, and performance indicators of production resources.

The term “preprocessing” refers to a set of computational operations, such as data cleaning, missing-value handling, normalization, aggregation, and feature construction, that transform raw data into a form suitable for analysis and prediction.

The term “statistical analysis” refers to the application of quantitative methods, such as aggregation, correlation, regression, or distribution analysis, to derive patterns and measures from the information collection.

The term “time-series analysis” refers to analysis methods that treat data as ordered in time, such as trend estimation, seasonality detection, or forecasting models, in order to understand and predict temporal behavior.

The term “machine learning algorithm” refers to a computational procedure that automatically builds or updates a model from data, such as a regression model, a classification model, or a clustering model, to perform prediction, classification, or pattern discovery.

The term “future business balance” refers to a predicted quantitative measure of business performance, including at least forecasted revenue, expenses, and profit, computed for a future time period based on the information collection.

The term “demand” refers to a predicted quantity of goods or services that will be requested or consumed in a future time period.

The term “optimize inventory quantities and procurement plans” refers to computing, by using at least one optimization method, inventory levels and purchase amounts that satisfy constraints such as capacity and service level while minimizing or maximizing a specified objective function.

The term “text information” refers to character-based content, such as messages, feedback, or descriptions, input or produced in natural language.

The term “audio information” refers to sound-based signals, such as speech or vocal expressions, captured by an input device and processed by the system.

The term “image information” refers to visual signals, such as still images or video frames, representing at least a user's face or body, captured by an image sensor.

The term “emotional state” refers to a classification of the user's psychological condition, such as joy, neutrality, anxiety, or anger, inferred by analyzing at least one of text information, audio information, and image information.

The term “context information” refers to a set of machine-readable parameters and descriptors that encode prediction results, optimization results, user emotional state, and other relevant conditions for use in strategy selection and prompt generation.

The term “aggressive business strategy” refers to a plan of actions characterized by higher risk and higher expected growth, such as expansion of investment or marketing activities, selected based on conditions including a favorable forecast and a non-negative emotional state.

The term “conservative business strategy” refers to a plan of actions characterized by lower risk and emphasis on stability or cost control, such as budget reduction or risk mitigation, selected based on conditions including an unfavorable forecast or a negative emotional state. The term “alert information” refers to data representing a notification about a condition of interest, such as an abnormality, threshold violation, or risk, including at least a type, severity, and associated explanation.

The term “importance and presentation order of alert information” refers to a ranking or prioritization of individual alerts that determines their relative significance and the order in which they are displayed or communicated to the user.

The term “generative artificial intelligence model” refers to a computational model, such as a neural-network-based language model, configured to generate new text or other content in response to an input prompt sentence.

The term “business-strategy proposal text” refers to generated natural-language content that proposes one or more business actions or plans, produced by the generative artificial intelligence model based on supplied context information.

The term “explanatory text” refers to generated natural-language content that explains prediction results, model behavior, optimization decisions, or recommended actions in a human-readable form.

The term “report” refers to a composite output that includes at least one of a business-strategy proposal text, an explanatory text, numerical prediction results, and visualization information, arranged for presentation to the user.

The term “numerical prediction results” refers to quantitative outputs produced by the prediction processes, such as predicted demand values, forecasted revenue, or risk scores. The term “visualization information” refers to data or graphical representations, such as charts, graphs, or diagrams, that depict numerical or categorical results in a format suitable for rendering on a display.

The term “visually understandable format” refers to a representation of information that is arranged and encoded so that it can be rendered on a display device as human-readable text and graphics.

The term “business data” refers to operational and financial information related to ongoing business activities, including at least sales events, cost events, and performance metrics, that are updated over time.

The term “abnormality” refers to a condition in which a current value or pattern of business data or inventory data deviates from a prediction result or a predetermined threshold in a manner that satisfies a defined detection criterion.

The term “priority of alert information” refers to a level or ordering value assigned to each alert, which influences how prominently, how quickly, or in what sequence the alert is communicated to the user.

The term “natural-language processing” refers to a set of computational techniques that analyze and interpret natural-language text, including at least tokenization, parsing, and semantic or sentiment analysis.

The term “emotion-analysis technique” refers to an algorithm or procedure that infers an emotional category or score from natural-language text by analyzing linguistic features.

The term “emotion-recognition model” refers to a computational model, such as a machine-learning or deep-learning model, that estimates an emotional state from non-textual input signals, including facial images and voice signals.

The term “text-based emotion estimation result” refers to an intermediate output that indicates an emotional category or score derived exclusively from text information.

The term “signal-based emotion estimation result” refers to an intermediate output that indicates an emotional category or score derived from non-textual signals, including at least audio information and image information.

The term “final emotional state” refers to an emotional classification or score derived by combining at least one text-based emotion estimation result and at least one signal-based emotion estimation result according to a combination rule.

The term “deviation between prediction results and actual values” refers to a difference or error measure computed between predicted business balance or demand and corresponding realized outcomes.

The term “retrain and update prediction models” refers to the act of executing machine learning algorithms again using updated data to adjust model parameters, and replacing or modifying existing models used for prediction.

The term “explanation information” refers to structured data summarizing at least prediction accuracy, model changes, and reasons or indicators used in updating prediction models, which can be used as input to a generative artificial intelligence model.

The term “explanation report” refers to an output document generated at least in part by a generative artificial intelligence model, which explains model performance, prediction deviations, and model updates in a human-readable narrative.

The term “real time” refers to a mode of operation in which data are processed and analyzed with a latency that is sufficiently low for the results or alerts to be used during the ongoing business activity without substantial delay.

In one embodiment, a server implements the claimed system by executing computer-readable instructions stored in a memory. The server includes at least one processor, a main memory, a non-volatile storage device, and a network interface. The server is connected via a communication network to at least one user terminal. The user terminal is implemented by a computing device such as a smartphone, a tablet device, or a personal computer equipped with a display, an audio input device, an image capture device, and a communication interface.

The server uses a relational database system as the storage device. In one configuration, the server uses a relational database engine to maintain tables for transactional information, cost information, inventory information, production information, user emotion state, alerts, strategy recommendations, external content, and model metadata. The server uses a data-analysis runtime implemented in a programming language such as a high-level scripting language providing libraries for data processing, numerical computation, machine learning, and graphics rendering.

The server receives a prompt sentence from the user terminal. The user operates the terminal to input the prompt sentence in a natural language through a graphical user interface component. The terminal transmits the prompt sentence to the server via a network protocol such as HTTPS. The server stores the received prompt sentence, together with a user identifier and a timestamp, in a log table in the database. The server uses a language-processing library to tokenize the prompt sentence, perform part-of-speech tagging, and extract entities and intents, such as requested data categories, relevant time ranges, and external information topics.

The server acquires related information from at least one external information source and at least one internal information source on the basis of the semantic structure of the prompt sentence. The server uses a web communication client to access external information sources such as news feeds, industry information sites, or open data portals. The server uses a document parsing library to extract main text sections, publication dates, titles, and tags from retrieved web documents. The server stores these elements as structured records in external-content tables with fields such as source identifier, topic identifier, and text content.

The server also acquires related information from internal information sources by issuing structured queries to its relational database. The server transforms abstract intents extracted from the prompt sentence into query conditions over schema elements. For example, when the prompt sentence refers to “last 12 months of sales data,” the server constructs an internal query that selects rows from a transactional table whose date field falls within the specified time range and whose transaction type corresponds to a sales category. The server stores the results into in-memory tabular data structures with explicitly typed columns.

The server converts all acquired information into a structured format suitable for analytic processing. The server represents tabular business data as data frames with typed columns such as date, product identifier, location identifier, quantity, and value. The server represents unstructured text from external information sources using tokenized and normalized text fields, augmented by metadata indicating topic, source, and publication time. The server augments these data frames with derived features, such as moving averages, seasonal indices, and lagged values, by applying numerical transformations.

The server preprocesses the structured data to improve quality and analytical suitability. The server uses missing-value handling functions to impute missing entries based on statistical rules such as median imputation per category or forward-filling within time series. The server applies outlier detection based on robust statistical measures, such as interquartile range thresholds or z-score limits, and either caps anomalous values or flags them in separate indicator columns. The server encodes categorical fields such as product family or region into numerical representations, using schemes such as one-hot encoding or target encoding, to feed them into machine-learning algorithms.

The server analyzes the data by performing statistical analysis, time-series analysis, and prediction using machine-learning algorithms. In one embodiment, the server uses a regression algorithm provided by a machine-learning library to estimate relationships between explanatory variables and target values such as demand, cost, or revenue. The server computes regression coefficients by minimizing an objective function such as mean squared error on training data sets. The server uses the resulting model parameters to compute predictions for unseen data, thereby producing forecasted business-balance values and demand values.

The server also performs time-series analysis by fitting parametric models to ordered sequences of numerical values. In one configuration, the server fits an autoregressive integrated model to monthly sales per product or per location. The server determines orders of the model by examining information criteria such as the Akaike information criterion. The server calculates predicted future values by iteratively applying the model equations using the estimated parameters and the most recent observed values. The server stores predicted values in forecast tables linked to the corresponding time intervals and entities.

The server optimizes inventory quantities and procurement plans by using an optimization engine. The server constructs an optimization problem in terms of decision variables representing order quantities per stock-keeping unit and period. The server defines constraints such as non-negativity, upper capacity limits, budget limits, minimum service levels, and supplier-related constraints. The server defines an objective function such as minimization of total cost, including holding cost, ordering cost, and penalty cost for stockouts. The server invokes a linear or mixed-integer programming solver to compute optimal values of decision variables. The server writes the computed decision variables and associated derived metrics, such as recommended safety-stock levels, into inventory-policy tables.

The server estimates a user's emotional state by analyzing text information, audio information, and image information obtained from a user. The terminal captures text input entered by the user via a keyboard or touch-screen interface. The terminal may also capture user audio using a microphone and capture user facial images using a camera. The terminal transmits these signals to the server using secure channels. The server processes the text using an emotion-analysis pipeline that computes sentiment scores and emotion labels using features such as word embeddings, n-gram frequencies, and syntactic patterns. The server processes the audio by extracting acoustic features such as pitch, energy, and spectral characteristics, and processes facial images by extracting spatial feature maps using a convolutional architecture. The server feeds these features into trained classifiers that output probability distributions over emotion categories such as joy, neutrality, anxiety, and anger. The server combines text-based and signal-based emotion estimation results to obtain a final emotional state. In one embodiment, the server computes a weighted average of posterior probabilities from different modalities, where weights are determined according to signal quality metrics or historical performance statistics. The server selects the emotion category with the highest combined probability as the final emotional state. The server stores this final emotional state, together with confidence scores and timestamps, in an emotion-state table linked to the user and session.

The server generates context information for selecting an aggressive or conservative business strategy based on both analytical results and emotional state. The server aggregates prediction outputs, optimization outputs, and risk indicators into a context record. This context record includes fields such as forecast trend direction, forecast uncertainty, current deviation between forecast and actual values, recommended inventory policies, cost-anomaly counts, and the final emotional-state label. The server applies a set of non-conventional decision rules that map combinations of forecast metrics and emotion categories to strategy polarity. For example, when forecasts indicate growth above a threshold and the emotional state is non-negative, the server tags the context as suitable for an aggressive strategy; when forecasts indicate decline or high uncertainty and the emotional state is anxious or negative, the server tags the context as suitable for a conservative strategy.

The server adjusts importance and presentation order of alert information using the emotional state and analytic results. The server assigns each alert a base severity computed from threshold violations, predicted impact, and duration. The server then modifies the base severity by applying transformation functions conditioned on emotional state and alert category. For instance, the server may increase the effective severity of cash-flow-related alerts under an anxious emotional state, while decreasing non-critical informational alerts. The server sorts alerts according to effective severity and stores the resulting order as a priority index used by the terminal for display. This reduces the number of low-relevance alerts transmitted and rendered, thereby improving communication efficiency and user attention allocation.

The server generates a further prompt sentence for a generative AI model using the context information. The server creates a structured textual description that encodes the analytic context and strategy polarity in a human-readable form, using templates that insert numerical values and categorical labels. For example, the server may generate a prompt sentence such as:
“You are a business advisor. Current forecasts show that next quarter's revenue is expected to grow by 8% with medium uncertainty. Inventory optimization recommends increasing safety stock for top products by 15%. The manager is currently feeling anxious. Propose a conservative strategy for the next quarter focusing on cost control and risk reduction, and explain the reasoning.”

The server transmits this prompt sentence to a generative AI model through an application programming interface. The generative AI model is implemented as a deep neural network, for instance a transformer-based language model trained on large text corpora using unsupervised learning objectives such as masked language modeling or next-token prediction. The server receives generated text comprising a business-strategy proposal text and an explanatory text from the generative AI model. The server optionally performs post-processing such as length normalization, removal of unwanted tokens, and consistency checks with the underlying numerical context.

The server generates a report that includes the business-strategy proposal text, the explanatory text, numerical prediction results, and visualization information. The server uses a visualization library to render charts that depict historical and forecasted values, distributions of costs, and impacts of recommended inventory policies. The server combines the textual and graphical elements into a document layout represented in a markup language. The server sends the report to the user terminal, which renders the report on its display in a visually understandable format. In one example, the report includes a chart of monthly sales over two years, with forecasted values highlighted, and a textual section generated by the generative AI model explaining why a conservative strategy is appropriate.

The server monitors business data and inventory data in real time. The server receives streaming updates from transaction sources, inventory systems, and production equipment via message queues or event streams. The server maintains rolling windows of recent data in memory and continuously applies detection rules comparing observed values to predicted baselines or thresholds. When the server detects an abnormality, such as a deviation exceeding a dynamically computed tolerance band or a stock level falling below a recommended safety threshold, the server creates an alert record with associated analytical context and emotional-state-adjusted priority. The server transmits critical alerts to the user terminal using push notification mechanisms; the terminal renders these notifications as banners, modal dialogs, or entries in an alert list.

The terminal presents alerts, reports, and related information using graphical components optimized for prioritization and clarity. The terminal obtains, from the server, both the ordered alert list and descriptive metadata. The terminal displays the alerts sorted by priority, using visual cues such as color coding or icons to emphasize severe alerts. The terminal also provides interactive controls that allow the user to request additional explanations, such as a button that triggers the server to send another prompt sentence to the generative AI model describing the cause of a specific alert.

The user interacts with the system by reading the displayed information, confirming or adjusting suggested plans, and inputting additional prompt sentences. The user may input a prompt sentence such as:
“Using my last 12 months of sales data, predict next quarter's sales and suggest cost-reduction measures.”

The server processes this prompt sentence in the same manner, acquiring and analyzing data, constructing context, generating a further prompt for the generative AI model, and returning a tailored report. This interaction pattern allows the system to dynamically reconfigure data acquisition and analysis pipelines based on natural-language instructions without manual code changes.

The server improves computer performance and data management through the described architecture. By converting natural-language prompt sentences into structured internal representations and schema-level queries, the server reduces redundant data retrieval and minimizes unnecessary data storage. By maintaining a modular pipeline—comprising acquisition, preprocessing, analysis, optimization, emotion estimation, context generation, prompt construction, generative-model invocation, and visualization—the server can independently scale and parallelize individual stages. For example, the server can cache intermediate feature matrices and reuse them for multiple strategy-generation requests, reducing repeated computation and disk access.

The server improves prediction accuracy and robustness by continuously computing deviation between prediction results and actual outcomes. The server stores realized sales, costs, and inventory events and periodically compares them to previously stored forecasts. When the server detects that an error metric such as mean absolute percentage error exceeds a specified threshold over a defined period, the server automatically schedules retraining of underlying models. During retraining, the server reuses the same preprocessing logic and feature construction, but adjusts model parameters using optimization algorithms such as stochastic gradient descent or quasi-Newton methods, minimizing a loss function defined over the new data. The server stores updated model parameters and records the change in model metadata, including training time, training data version, and evaluation metrics. The server generates explanation information summarizing the retraining process, including changes in error metrics, identified drift in demand patterns, and modifications in model hyperparameters such as number of layers, number of units per layer, or regularization strength. The server formats this explanation information into a prompt sentence for the generative AI model. An example of such a prompt sentence is:
“Explain in non-technical language why the sales forecast model was retrained this month. The previous model had a mean absolute percentage error of 18%, while the new model has 9%. Describe the main changes in demand patterns and how the updated model addresses them.”

The generative AI model returns an explanation report that the server makes available to the user upon request. This automated explanation mechanism reduces the need for manual interpretation by technical staff and improves transparency while using the computing infrastructure to generate structured, consistent narratives.

The described system produces technical effects that go beyond mere automation of manual business processes. The system reduces network and processing load by constructing prompt-driven, context-aware data retrieval operations rather than indiscriminately pulling large data sets. The system reduces user-interface clutter and cognitive load by algorithmically prioritizing alerts using a combination of analytical severity metrics and emotional-state feedback, thereby optimizing the use of display resources and notification channels. The system improves computation efficiency by reusing intermediate analytical results in constructing prompts and reports, reducing redundant execution of heavy algorithms. The system improves prediction performance and stability through continuous, criteria-based retraining, which is automatically triggered by quantified deviations, not by human scheduling alone.

The system also implements non-conventional processing by combining multi-modal emotion estimation with predictive analytics to control model behavior and generative content. The server does not simply apply fixed business rules; instead, it integrates signals from text, audio, and images into a unified emotional-state representation, which then affects how alerts are ranked, which strategy polarity is selected, and how prompt sentences are framed for the generative AI model. This results in a feedback loop in which user context directly influences the internal computational pathways and resource allocation decisions of the server, rather than only changing superficial display properties.

In alternative embodiments, the server may implement different machine-learning architectures, such as gradient-boosted decision trees for tabular prediction tasks, recurrent architectures for sequence modeling, or probabilistic graphical models for risk assessment. The server may use different optimization solvers, such as interior-point or simplex-based solvers, and different emotion-recognition modules, such as lightweight models deployed at the terminal with only aggregated results sent to the server. The server may perform partial processing at the edge by allowing the terminal to execute pre-filtering, local caching, or preliminary emotion estimation, thereby reducing bandwidth and central processing requirements. The overall structure of using prompt sentences to orchestrate multi-source acquisition, structured analysis, emotion-aware control, and generative-model interaction remains the same.

The terminal can also support various user-interface variants. In one variant, the terminal implements a dashboard layout that dynamically rearranges sections according to alert priorities and strategy context received from the server. In another variant, the terminal supports voice input and output, converting user utterances into prompt sentences and reading back key parts of generated reports. The server adapts its internal processing pipeline to these interface modalities by adjusting prompt-construction templates and response payloads. Through these embodiments and variations, the server, the terminal, and the user cooperate in a technically structured manner. The server implements detailed data structures, processing modules, and machine-learning models; the terminal handles capture and display with priority-sensitive layouts; and the user interacts primarily through prompt sentences and feedback. This configuration allows other implementers, by following the described architecture and processing methods, to realize the invention and obtain the same technical advantages in terms of performance, accuracy, manageability, and intelligent use of computational resources in a decision-support computing environment.

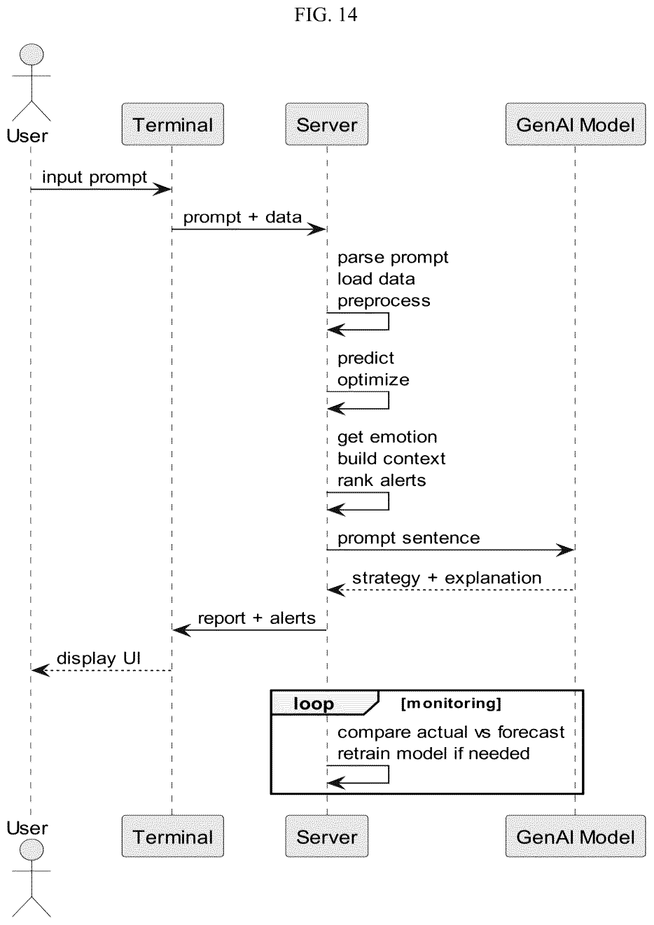

The following describes the processing flow using FIG. 14.

### Step 1:

The user operates the terminal to input a prompt sentence and optional business data.

The user types a natural-language prompt sentence into an input field of the terminal, such as “Using my last 12 months of sales data, predict next quarter's sales and suggest cost-reduction measures.” The user optionally selects and uploads data files (for example CSV or spreadsheet files containing sales, cost, or inventory records).
Input: user-entered prompt sentence; user-selected data files.
Output: an HTTP request from the terminal to the server containing the prompt sentence, metadata (user ID, time), and any attached files.

### Step 2:

The terminal transmits the prompt sentence and files to the server.

The terminal packages the prompt sentence and file contents into a request body (for example multipart/form-data or JSON) and sends the request via HTTPS to a designated application programming interface endpoint of the server. The terminal includes authentication tokens so that the server can associate the request with a user account.
Input: prompt sentence and data files in the terminal's memory; network configuration.
Output: a network message arriving at the server, carrying the prompt sentence and raw file data.

### Step 3:

The server receives the request and parses the prompt sentence and files.

The server accepts the network message at its communication interface, decodes HTTP headers, and extracts the prompt sentence and binary file contents. The server writes the uploaded files to temporary storage locations and records the prompt sentence, user ID, and timestamps into a log table in a database. The server uses a language-processing module to tokenize the prompt sentence, detect key phrases (for example “last 12 months,” “predict next quarter,” “cost reduction”), and classify the intent.
Input: network message containing prompt sentence and files.
Output: stored files on disk, a parsed prompt object (containing intent, time range, requested tasks), and a log record in the database.

### Step 4:

The server loads or ingests business data into structured data frames.

The server reads any newly uploaded files and converts them to tabular structures, mapping columns to standardized field names such as date, item identifier, quantity, unit price, and category. The server also queries internal databases for additional records referenced by the prompt sentence (for example “last 12 months of sales” or “current inventory levels”). The server merges external and internal sources into unified data frames.
Input: temporary files; parsed prompt object; database connection.
Output: in-memory data frames representing transactional information, cost information, and inventory information.

### Step 5:

The server preprocesses the structured data for analysis.

The server examines each data frame, detects missing values, and applies rules such as median imputation or forward-filling along time axes. The server computes statistical measures such as mean and standard deviation and identifies outliers using thresholds; the server either caps or flags these outliers in dedicated columns. The server converts categorical fields into numerical encodings to be used as features, and aggregates raw records into time-based summaries (for example daily or monthly totals per product).
Input: raw data frames from Step 4.
Output: cleaned and feature-enriched data frames ready for modeling, and optional quality-indicator fields.

### Step 6:

The server performs statistical analysis and prediction using machine-learning algorithms. The server splits the preprocessed data into training and validation sets based on time or cross-validation schemes. The server trains prediction models, such as regression models, by minimizing an error function (for example mean squared error) on the training set. The server then applies the fitted models to the most recent data to compute future values (for example future demand, revenue, or cost). The server evaluates error metrics on the validation set to assess model quality.
Input: cleaned data frames and configured model parameters or hyperparameters.
Output: predicted business-balance values (for example forecasted revenue and profit), demand forecasts per product and period, and associated evaluation metrics.

### Step 7:

The server performs time-series forecasting for targeted metrics.

The server selects time-ordered sequences (for example monthly sales per product) and fits time-series models to these sequences. The server determines model order parameters based on statistical criteria and computes future points by iteratively applying the model equations. The server generates forecast series that extend beyond the last observed date.
Input: time-indexed data extracted from the preprocessed data frames.
Output: forecast time series for each selected metric, stored as arrays or tables with future time stamps and predicted values.

### Step 8:

The server optimizes inventory quantities and procurement plans.

The server constructs an optimization model where decision variables represent order quantities per product and period. The server defines constraints (for example warehouse capacity, budget, lead times, and minimum stock levels) using parameters obtained from the database. The server formulates an objective function, such as minimizing total expected cost, and calls an optimization solver to compute optimal decision-variable values. The server writes the solver's solution back into an inventory-policy table.
Input: demand forecasts from Steps 6-7; constraint parameters from internal tables.
Output: optimal order quantities, safety-stock levels, and related cost estimates.

### Step 9:

The server acquires user-related signals for emotion estimation.

The terminal captures text, audio, or image data from the user during interaction (for example written comments, spoken feedback, or facial snapshots) and transmits these signals to the server. The server receives and stores these signals and associates them with the current session.
Input: text strings, audio samples, and image frames provided by the terminal.
Output: stored multi-modal signal records linked to a user and session.

### Step 10:

The server estimates the user's emotional state from multi-modal inputs.

The server processes text input through a natural-language module that computes features such as token embeddings and sentiment scores, then classifies the text into emotion categories (for example joy, neutral, anxious, angry). The server processes audio samples to extract acoustic features and applies a classifier trained to map these features to emotion probabilities. The server processes facial images using a neural network that outputs probabilities for facial-expression-based emotions. The server combines these probability distributions using a weighting scheme and selects the highest-probability emotion as the final emotional state.
Input: multi-modal signal records from Step 9; pre-trained classifiers and feature-extraction models.
Output: a final emotional-state label and confidence scores, stored in an emotion-state table.

### Step 11:

The server constructs analytic and contextual summaries.

The server aggregates prediction outputs, optimization results, risk indicators (for example probability of stockout), and the user's current emotional state into a structured context object. The server computes derived indicators such as growth rates, forecast uncertainty levels, and deviations between forecast and actual values. The server maps combinations of these indicators and emotional-state labels to a selected strategy polarity (for example aggressive or conservative).
Input: prediction results from Steps 6-7; optimization results from Step 8; emotion label from

### Step 10.

Output: a context object containing metrics, flags, and a recommended strategy polarity.

### Step 12:

The server adjusts alert severity and order using analytic context and emotional state. The server retrieves pending or newly generated alerts, each with a base severity derived from underlying conditions (for example threshold violations or anomaly scores). The server recalculates the effective severity for each alert using functions that depend on emotional state and alert category, such as increasing severity for risk-related alerts when the user is anxious. The server sorts alerts according to effective severity and stores the updated priority order.
Input: alert records with base severities; context object containing emotional state.
Output: a prioritized alert list with updated severity scores and display order.

### Step 13:

The server generates a prompt sentence for a generative AI model using the context. The server composes a textual description of the current analytic situation, inserting numerical values and labels from the context object into a template. For example, the server generates: “You are a business advisor. Current forecasts show that next quarter's revenue is expected to grow by 8% with medium uncertainty. Inventory optimization recommends increasing safety stock for top products by 15%. The manager is currently feeling anxious. Propose a conservative strategy for the next quarter focusing on cost control and risk reduction, and explain the reasoning.”
Input: context object with forecast metrics, optimization summary, and emotional-state label.
Output: a constructed prompt sentence ready to be sent to the generative AI model.

### Step 14:

The server calls the generative AI model and receives generated text.

The server sends the constructed prompt sentence to an external or internal generative AI model endpoint via an application programming interface, specifying required parameters such as maximum length or sampling temperature. The generative AI model processes the prompt and returns generated natural-language content. The server separates this content into a business-strategy proposal portion and an explanatory portion based on markers or structure.
Input: prompt sentence from Step 13; generative-model API configuration.
Output: a proposal text and an explanatory text generated by the generative AI model.

### Step 15:

The server generates visualizations and assembles a report.

The server uses visualization routines to create graphical representations of the forecast data, cost breakdowns, and inventory recommendations (for example line charts of past and forecast values, bar charts of costs, and tables summarizing recommended orders). The server then assembles a report object that includes the generated proposal text, the explanatory text, the graphical elements, and selected numerical tables. The server formats the report for delivery to the terminal, such as in a structured markup format or a JSON document with embedded chart specifications.
Input: prediction and optimization results; proposal text and explanatory text from Step 14.
Output: a complete report object containing narrative, numerical, and graphical elements.

### Step 16:

The terminal receives and displays the report and alerts to the user.

The terminal obtains the report and the prioritized alert list from the server via HTTP responses or push notifications. The terminal parses the report structure and renders textual sections, graphs, and tables on the display. The terminal displays alerts in sorted order, visually highlighting higher-severity items. The terminal may provide interactive controls allowing the user to expand details or request additional explanation.
Input: report object and prioritized alert list from the server.
Output: a rendered user interface showing the report and alerts on the terminal's display.

### Step 17:

The user reviews information and issues further instructions.

The user reads the strategy proposal, examines charts and tables, and inspects high-priority alerts. Based on this information, the user may decide on actions (for example adjusting order quantities or budgets) and may input further prompt sentences such as “Re-evaluate the plan assuming marketing costs are reduced by 10%” or “Explain why the inventory recommendation for Product A increased compared to last month.” The terminal sends these new prompt sentences back to the server, thereby initiating another pass through the processing flow.
Input: displayed report and alerts; user interpretation and follow-up prompt sentence.
Output: new user requests and prompt sentences transmitted to the server for subsequent processing.

### Step 18:

The server monitors actual data and evaluates model performance over time.

The server continuously logs realized business data (for example actual sales and costs) and compares them with previously stored forecast values. The server computes deviation metrics such as mean absolute percentage error for each forecast horizon. When deviations exceed defined thresholds, the server flags models for retraining. The server uses updated data sets to re-run preprocessing and model-training procedures, calculates new parameters, and records changes in a model-metadata table. The server optionally generates explanation information about these updates and can construct new prompt sentences for the generative AI model, such as “Explain in non-technical language why the sales forecast model was retrained this month . . . ”
Input: realized business data streams; stored forecast records; thresholds for acceptable error.
Output: updated error metrics, retrained model parameters, model-change summaries, and optional explanation prompts and reports.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

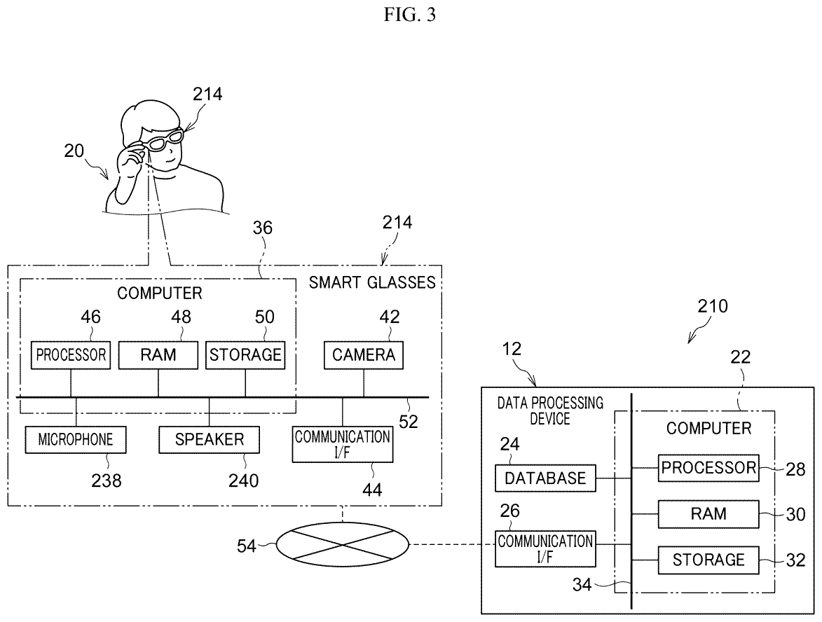

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

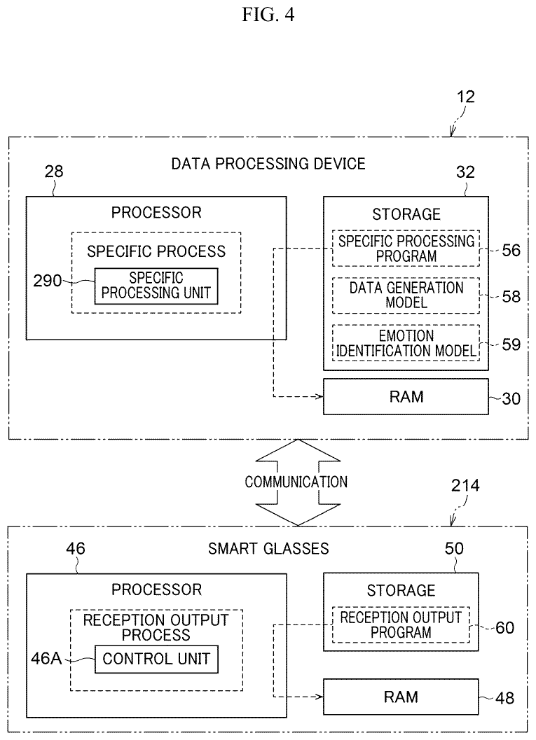

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

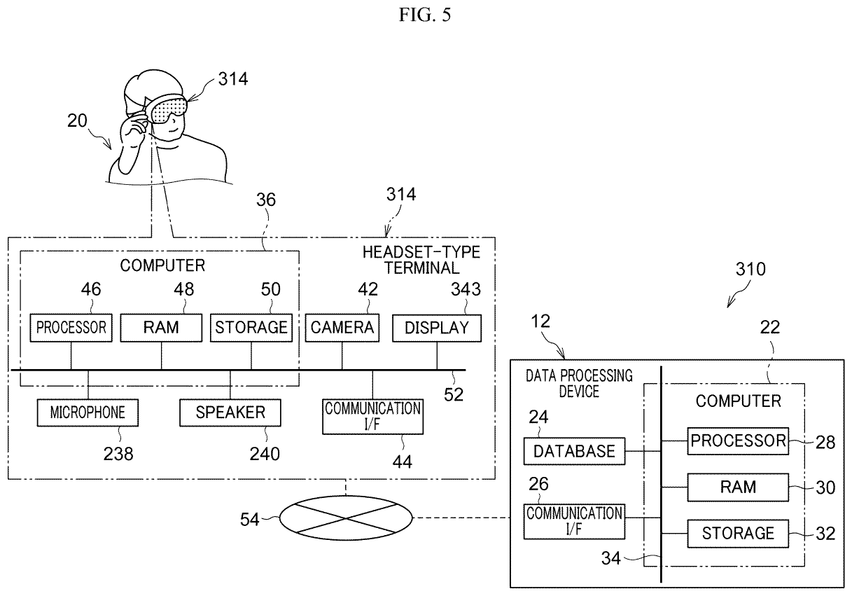

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

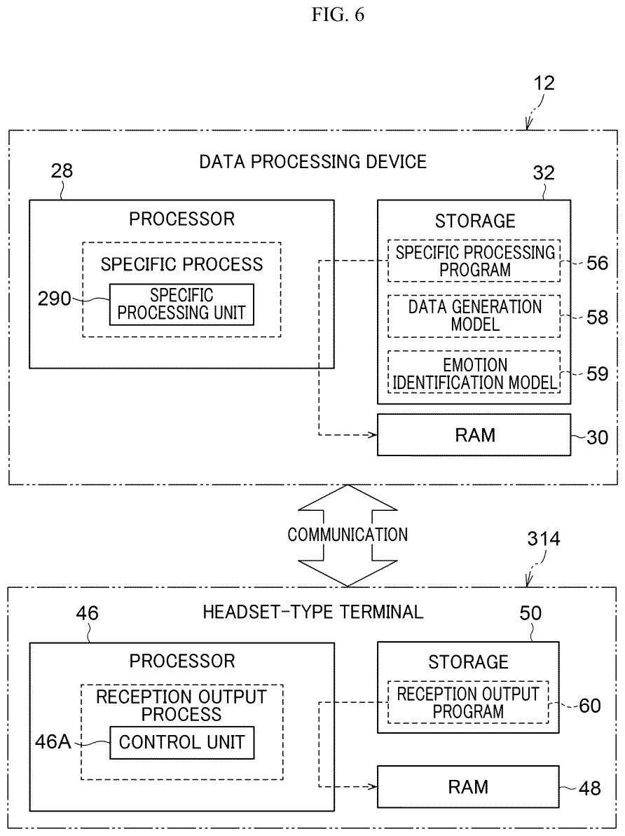

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

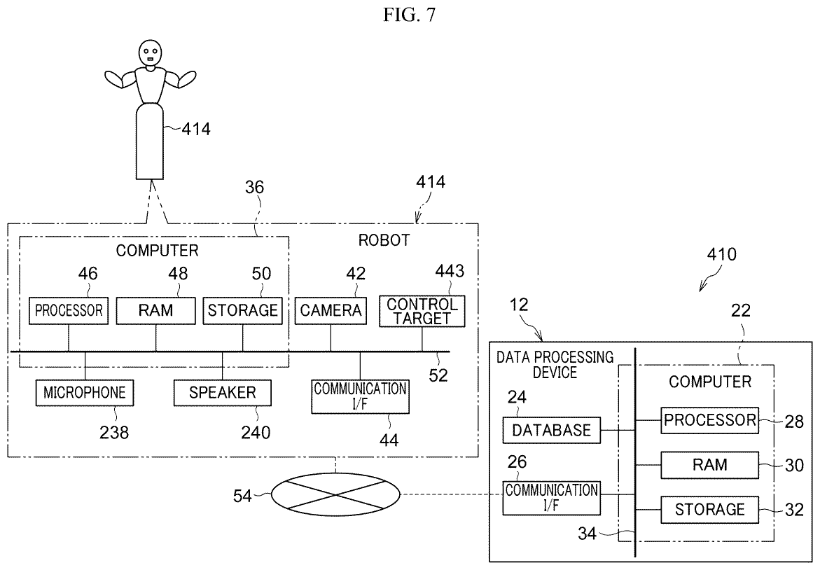

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

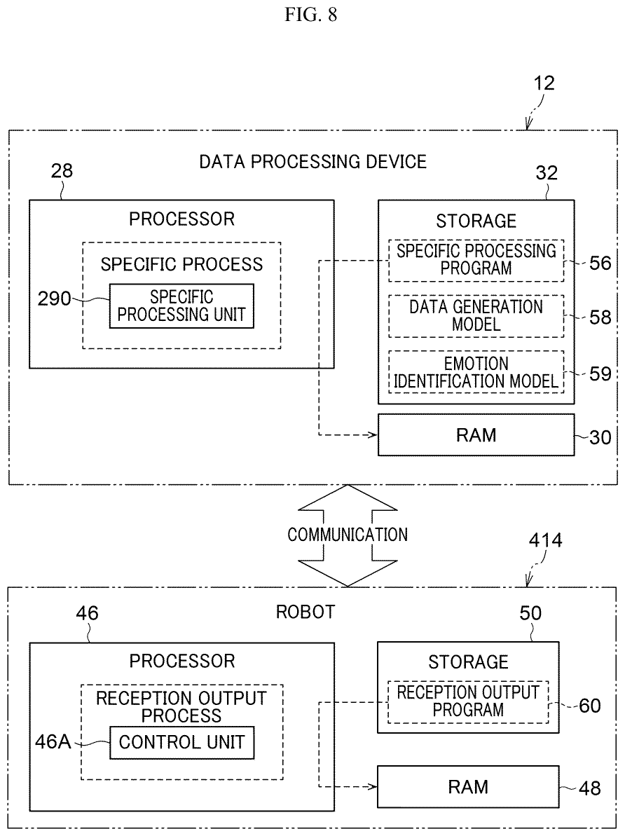

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

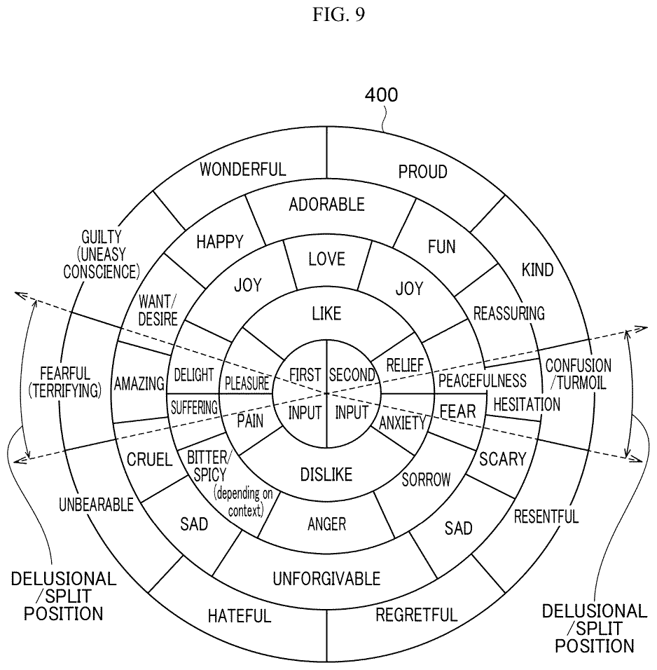

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

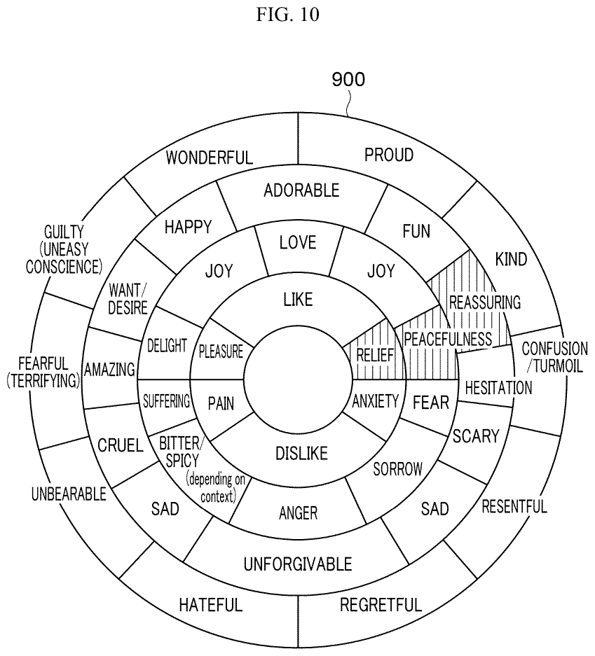

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive, from a terminal operated by a user, a prompt sentence expressed in natural language, the prompt sentence instructing acquisition, processing, and presentation of business-related information from an external information source, and store the prompt sentence as input data, analyze the prompt sentence by using a generative AI model so as to generate structured control information that includes at least a type of business data to be acquired, a period of the data to be acquired, and a content of processing to be executed,
control, on the basis of the structured control information, automatic acquisition of business data via a communication network from a plurality of external information sources, normalize the acquired business data into a unified data schema, and store the normalized business data in a data storage device,
execute, by using a data processing program running on a computation device and by using a tabular data processing software library, formatting, preprocessing, and aggregation of the business data stored in the data storage device to generate formatted business data,
execute, by using a machine learning software framework, time-series analysis and prediction computation on the formatted business data to calculate at least a future business balance and related indicators as prediction results,
structure the prediction results and the formatted business data as report data sets, and output the report data sets to a visualization information processing device or visualization software as report generation data,
cause a display device to generate, on the basis of the report data sets, a visual report including at least a graph, a table, and an indicator display, and to present the visual report to the user via the terminal,
re-execute at least a part of one or more of the analysis of the prompt sentence, the automatic acquisition of business data, the formatting, the time-series analysis, the prediction computation, and the structuring of the report data sets in response to reception of a new prompt sentence from the terminal, and update dynamically a content of the visual report in accordance with the new prompt sentence, and
monitor execution states of the automatic acquisition of business data, the formatting, and the prediction computation, and a state of information acquisition from the external information sources, detect an abnormality based on the execution states and the state of information acquisition, and, when the abnormality is detected, transmit alert information to the terminal.

### Supplementary 2

The system according to supplementary 1,
wherein the processor is configured to generate, by using the generative AI model, workflow information in a machine-readable format from the prompt sentence, the workflow information including at least one identifier of an external information source, a target acquisition period, a type of business data to be acquired, and an output format, and to automatically construct, on the basis of the workflow information, a sequence of communication processing with the external information sources and a sequence of internal data processing.

### Supplementary 3

The system according to supplementary 1,
wherein the processor is configured to provide the formatted business data and the prediction results, obtained by the tabular data processing software library and the machine learning software framework, as report data sources to the visualization information processing device, and to cause the visualization information processing device to generate a dashboard-type screen in which time-series graphs, aggregated tables, and indicator displays are associated with each other on the basis of layout information so that the visual report is displayed in an interactive dashboard format.

### Application Example 1

### Supplementary 1

A system comprising a processor,
wherein the processor is configured to
receive, from a user terminal, a prompt sentence in natural language for instructing acquisition of information from an external information source and an internal information source,
acquire time-series data from a sensing device via a communication network and store the acquired time-series data as raw data in a storage device,
convert, by execution of an information processing program, the raw data and the information acquired from the external information source into analysis data by performing format conversion, missing-value imputation, time normalization, attribute assignment, and aggregation processing, and store the analysis data in the storage device,
analyze the analysis data by using a statistical analysis function and a machine learning function so as to predict a future transition of performance indices related to operational activities, a possibility of anomaly occurrence, and efficiency-degradation intervals, calculate evaluation indices based on prediction results and detection results obtained by the analysis, compare the evaluation indices with predetermined thresholds to determine an abnormal event or a bottleneck, and record an event record representing the determination result in the storage device,
generate report data including at least one of time-series graphs, bar graphs, and lists of indices by using a visualization program based on the analysis results and the event record, and configure visualization information displayable via a display device,
automatically generate a prompt sentence to be input to a generative AI model based on the report data and summary information of the analysis results, the prompt sentence including the performance indices, anomaly-occurrence intervals, operating conditions, and constraint conditions,
transmit the automatically generated prompt sentence or a prompt sentence input by the user via the user terminal to the generative AI model, and receive a natural-language output including proposal information regarding optimization of operational efficiency from the generative AI model, and
store the proposal information in association with the report data in the storage device, present the proposal information on a user interface in a segmented manner, receive an acceptance or rejection instruction and a comment input from the user regarding each item of the proposal information, and record results of the acceptance or rejection instruction and the comment input in the storage device.

### Supplementary 2

The system according to supplementary 1,
wherein the processor is configured to
extract, from the storage device, the time-series data and the analysis results for a predetermined period, generate text information summarizing at least statistical values of the time-series data, periodic variation patterns, and past anomaly-occurrence histories, and construct the prompt sentence that instructs the generative AI model to create optimization proposals for operational efficiency with the text information included.

### Supplementary 3

The system according to supplementary 1,
wherein the processor is configured to
apply time-series analysis, regression analysis, and an anomaly-detection model to the analysis data to predict future values of the performance indices, and input, to the generative AI model, the prediction results and anomaly-detection results embedded in the prompt sentence so as to obtain decision-support information including at least a modification plan of an operation schedule, candidate timings of maintenance execution, and an adjustment plan of personnel allocation based on the prediction results.

### Example 2

### Supplementary 1

A system comprising a processor,
wherein the processor is configured to
cause a terminal to receive structured data including business-related historical data from a user and to transmit the structured data to a server via a communication network, and cause the server to execute a program on a general-purpose computing device to load the structured data into a tabular data structure, to perform preprocessing including completion of missing values, conversion of data types, aggregation based on time information, and generation of feature values, and to generate a preprocessed dataset, and
cause the server to apply statistical processing and machine learning processing to the preprocessed dataset to construct a prediction model for predicting future business indicators and a clustering model for classifying expense characteristics, and to calculate future values and cluster information based on the models, and
cause the server to generate a structured output including predicted values for future time points, comparative indicators, and aggregated values per cluster based on numerical results obtained by the prediction model and the clustering model, and to transmit the structured output to the terminal, and
cause the terminal to receive the structured output and present a visual display including a graph indicating time-series transitions, a table indicating classification results, and a highlighted display to the user, and
cause the terminal to receive a prompt sentence in natural language from the user and to transmit the prompt sentence to the server via the communication network, and
cause the server to use a generative artificial intelligence model, with the prompt sentence and context information relating to the structured data or the preprocessed dataset as input, to analyze the prompt sentence and to generate analysis instruction information including data selection, prediction target period, comparison condition, output format, and explanation style, and
cause the server, based on the analysis instruction information, to select or reconstruct the prediction model and the clustering model, to identify future values, comparison results, and time points at which an anomaly or a risk is expected, and to generate a summary explanation of the identified results, and to transmit analysis result data including the future values, the comparison results, the identified time points, and the summary explanation to the terminal, and
cause the terminal to receive the analysis result data, to display the summary explanation as text, and to visually emphasize the identified time points or clusters on the graph or the table and present the emphasized display to the user.

### Supplementary 2

The system according to supplementary 1,
wherein the processor is configured to
cause the server to provide to the generative artificial intelligence model, together with the prompt sentence, constraint information indicating available data sets, available analysis operation types, and a required output format, to obtain from the generative artificial intelligence model machine-readable instruction data including a task type, a prediction period, a comparison criterion, a visualization requirement, and an explanation requirement, and to control execution of the prediction model and execution of the clustering model based on the instruction data.

### Supplementary 3

The system according to supplementary 1,
wherein the processor is configured to
cause the server to associate future values calculated by the prediction model with past actual values for corresponding periods included in the structured data based on time information, to calculate differences or ratios of values in a same cycle in accordance with the instruction data from the generative artificial intelligence model, to automatically extract periods in which a business risk or a business opportunity is expected, and to include the extracted periods in the analysis result data transmitted to the terminal.

### Application Example 2

### Supplementary 1

A system comprising a processor,
wherein the processor is configured to
receive, from a user terminal, a prompt sentence that instructs retrieval of related information, and, on the basis of the prompt sentence, acquire related information from at least one external information source and at least one internal information source, convert the acquired information into a structured format, and automatically store the structured information into a storage device as an information collection,
analyze transactional information, cost information, inventory information, and production information stored in the information collection by performing preprocessing, statistical analysis, time-series analysis, and prediction using a machine learning algorithm, calculate future business balance and demand, and optimize inventory quantities and procurement plans,
analyze text information, audio information, and image information obtained from a user in order to estimate an emotional state of the user, and store the estimated emotional state in association with results of the prediction and the optimization,
generate context information for selecting an aggressive or conservative business strategy in accordance with the emotional state of the user, while adjusting importance and presentation order of alert information on the basis of the results of the prediction and the optimization and the emotional state,
generate a prompt sentence including the context information, input the prompt sentence to a generative artificial intelligence model so as to cause the generative artificial intelligence model to generate a business-strategy proposal text and an explanatory text, and generate a report including the proposal text, the explanatory text, numerical results of the prediction, and visualization information, and present the report to the user terminal in a visually understandable format, and
monitor business data and inventory data that are input in real time, detect an abnormality by comparing the business data and the inventory data with the results of the prediction or with a predetermined threshold, and, when the abnormality is detected, notify the user terminal of alert information whose priority has been adjusted on the basis of the emotional state.

### Supplementary 2

The system according to supplementary 1,
wherein the processor is configured to
analyze natural-language text input from the user by using natural-language processing and emotion-analysis techniques to classify the text into an emotion category, estimate the emotional state from facial information and voice information of the user by using an emotion-recognition model, and integrate a text-based emotion estimation result and a signal-based emotion estimation result to determine a final emotional state.

### Supplementary 3

The system according to supplementary 1,
wherein the processor is configured to
continuously calculate a deviation between the results of the prediction and the optimization and an actual business balance and an actual demand, retrain and update prediction models by using the information collection when the deviation satisfies a predetermined condition, generate explanation information including a prediction accuracy after updating and contents of model changes, use the explanation information as a prompt sentence to the generative artificial intelligence model so as to generate an explanation report, and present the explanation report in response to a request from the user terminal.

What is claimed is:

1. A system comprising:
circuitry configured to:
receive, via a communication interface coupled to a packet-switched network, a natural language instruction from a terminal device operated by a user;
analyze the natural language instruction using a generative neural network model to generate structured workflow data comprising at least an identifier of an external data source, a target acquisition period, and a processing specification;
acquire, based on the structured workflow data, source data from a plurality of external data sources via the packet-switched network;
convert the acquired source data into normalized data conforming to a unified data schema and store the normalized data in a storage device;
execute a prediction computation on the normalized data using a machine learning model to generate prediction result data; and
transmit, via the communication interface, response data comprising the prediction result data to the terminal device for presentation on a display of the terminal device.

2. The system according to claim 1, wherein the circuitry is further configured to:
execute, using a tabular data processing library, formatting, preprocessing, and aggregation operations on the normalized data stored in the storage device to generate formatted data prior to the prediction computation.

3. The system according to claim 2, wherein the prediction computation comprises executing a time-series analysis operation and a regression analysis operation on the formatted data to calculate at least a future balance value and one or more performance indicator values.

4. The system according to claim 3, wherein the circuitry is further configured to:
structure the formatted data and the prediction result data as report data sets; and
provide the report data sets to a visualization processing module configured to generate a visual report in an interactive dashboard format comprising time-series graphs, aggregated tables, and indicator displays associated with each other based on layout information.

5. The system according to claim 4, wherein the future balance value represents a predicted business income and expenditure balance, and the one or more performance indicator values comprise at least one of a revenue trend indicator, a cost variance indicator, and a cash flow projection indicator.

6. The system according to claim 1, wherein the analyzing the natural language instruction using the generative neural network model comprises:
inputting the natural language instruction as a prompt data sequence into the generative neural network model; and
obtaining, from the generative neural network model, the structured workflow data in a machine-readable format, the structured workflow data further comprising an output format specification and a sequence of data processing operations.

7. The system according to claim 6, wherein the circuitry is further configured to:
automatically construct, based on the structured workflow data, a sequence of communication operations with the plurality of external data sources and a sequence of internal data processing operations; and
execute the sequence of communication operations to acquire the source data.

8. The system according to claim 7, wherein the plurality of external data sources comprise at least one of an accounting data system, a transaction database, and a web-accessible data service, and wherein the source data comprises at least one of financial transaction records, operational activity records, and market indicator data.

9. The system according to claim 8, wherein the converting the acquired source data into normalized data comprises:
performing format conversion, missing-value imputation, time normalization, and attribute assignment operations on the source data; and
storing the normalized data in the storage device in a unified tabular format.

10. The system according to claim 1, wherein the circuitry is further configured to:
receive, via the communication interface, a subsequent natural language instruction from the terminal device; and
re-execute at least a portion of the analyzing, the acquiring, the converting, the prediction computation, and the transmitting in response to the subsequent natural language instruction to dynamically update the response data.

11. The system according to claim 1, wherein the circuitry is further configured to:
monitor execution states of the acquiring the source data and the prediction computation; and
detect an abnormality based on the execution states and, in response to detecting the abnormality, transmit alert data to the terminal device via the communication interface.

12. The system according to claim 11, wherein the abnormality comprises at least one of a communication failure with one of the plurality of external data sources, a data format inconsistency in the acquired source data, and a computation timeout in the prediction computation.

13. The system according to claim 1, wherein the circuitry is further configured to:
acquire, from a sensing device coupled to the terminal device via the packet-switched network, time-series sensor data; and
store the time-series sensor data in the storage device as additional source data,
wherein the prediction computation is executed on a combination of the normalized data and the time-series sensor data.

14. The system according to claim 13, wherein the time-series sensor data comprises operational activity measurement data, and wherein the prediction result data further comprises an anomaly occurrence probability and an efficiency degradation interval estimate.

15. The system according to claim 1, wherein the machine learning model comprises a time-series prediction model trained using a gradient-based optimization algorithm on historical data stored in the storage device.

16. The system according to claim 15, wherein the time-series prediction model comprises a neural network architecture including at least an input layer, one or more hidden layers with nonlinear activation functions, and an output layer configured to generate the prediction result data.

17. The system according to claim 1, wherein the generative neural network model comprises a transformer-based architecture including an embedding layer, a plurality of self-attention layers, and an output layer configured to generate a sequence of output tokens representing the structured workflow data.

18. A system comprising:
circuitry configured to:
receive, via a communication interface coupled to a packet-switched network, a natural language instruction from a terminal device, the natural language instruction specifying acquisition, processing, and presentation requirements for data from external data sources;
input the natural language instruction as a prompt data sequence into a generative neural network model comprising a transformer-based architecture and obtain structured workflow data comprising at least an identifier of an external data source, a target acquisition period, a type of data to be acquired, and an output format specification;
acquire, based on the structured workflow data, source data from a plurality of external data sources via the packet-switched network, normalize the acquired source data into a unified data schema, and store the normalized data in a storage device;
execute formatting, preprocessing, and aggregation operations on the normalized data using a tabular data processing library to generate formatted data;
execute a time-series analysis operation and a prediction computation on the formatted data using a machine learning model to generate prediction result data comprising at least a future balance value;
structure the formatted data and the prediction result data as report data sets and provide the report data sets to a visualization processing module to generate a visual report in an interactive dashboard format; and
transmit, via the communication interface, the visual report to the terminal device for presentation on a display of the terminal device.

19. The system according to claim 18, wherein the circuitry is further configured to:
monitor execution states of the acquiring the source data, the formatting, and the prediction computation;
detect an abnormality based on the execution states; and
in response to detecting the abnormality, transmit alert data to the terminal device via the communication interface.

20. A method comprising:
receiving, via a communication interface coupled to a packet-switched network, a natural language instruction from a terminal device operated by a user;
analyzing the natural language instruction using a generative neural network model to generate structured workflow data comprising at least an identifier of an external data source, a target acquisition period, and a processing specification;
acquiring, based on the structured workflow data, source data from a plurality of external data sources via the packet-switched network;
converting the acquired source data into normalized data conforming to a unified data schema and storing the normalized data in a storage device;
executing a prediction computation on the normalized data using a machine learning model to generate prediction result data; and
transmitting, via the communication interface, response data comprising the prediction result data to the terminal device for presentation on a display of the terminal device.
